(19) United States
(12) Patent Application Publication
(10) Pub. No.: US 2021/0108952 A1
(43) Pub. Date: Apr. 15, 2021

(54) MEASUREMENT CONTROL DEVICE AND FLOW VOLUME MEASURING DEVICE

(71) Applicant: DENSO CORPORATION, Kariya-city (JP)

(72) Inventors: Noboru KITAHARA, Kariya-city (JP); Kengo ITO, Kariya-city (JP); Teruaki KAIFU, Kariya-city (JP); Amane HIGASHI, Kariya-city (JP)

(21) Appl. No.: 17/132,292

(22) Filed: Dec. 23, 2020

Related U.S. Application Data
(63) Continuation of application No. PCT/JP2019/024196, filed on Jun. 19, 2019.

(30) Foreign Application Priority Data
Jul. 5, 2018 (JP) 2018-128497
Jun. 11, 2019 (JP) 2019-108845

(51) Int. Cl. G01F 1/72; G01F 1/69

(52) U.S. Cl. CPC G01F 1/72; G01F 1/69

(57) ABSTRACT

A measurement control device measures an air flow rate using an output value of a sensing portion that outputs a signal according to the air flow rate, and outputs the measurement result of the air flow rate to a predetermined external device. The measurement control device includes: a pulsation state calculator that calculates a pulsation state, which is a state of pulsation generated in the air flow rate, by using the output value of the sensing portion instead of acquiring an output value from an external device; and a flow rate correcting unit that corrects the air flow rate using the pulsation state calculated by the pulsation state calculator.

### CROSS REFERENCE TO RELATED APPLICATION

The present application is a continuation application of International Patent Application No. PCT/JP2019/024196 filed on Jun. 19, 2019, which designated the U.S. and claims the benefit of priority from Japanese Patent Application No. 2018-128497 filed on Jul. 5, 2018 and Japanese Patent Application No. 2019-108845 filed on Jun. 11, 2019. The entire disclosures of all of the above applications are incorporated herein by reference.

### TECHNICAL FIELD

The present disclosure relates to a measurement control device and a flow volume measuring device.

### BACKGROUND

A flow volume measuring device measures an air flow rate based on an output value of an air flow sensor. A pulsation frequency of the air flow rate is calculated, and the air flow rate is corrected using the pulsation frequency to reduce a pulsation error, which is an error caused by the pulsation of the air flow rate.

### SUMMARY

In the first aspect of the present disclosure, a measurement control device measures an air flow rate using an output value of a sensing portion that outputs a signal according to the air flow rate, and outputs the measurement result of the air flow rate to a predetermined external device. The measurement control device includes: a pulsation state calculator that calculates a pulsation state that is a state of pulsation generated in the air flow rate using an output value, instead of acquiring an output value from an external device; and a flow rate correcting unit that corrects the air flow rate using the pulsation state calculated by the pulsation state calculator.

In the second aspect, a flow volume measuring device measures an air flow rate, and includes: a measurement channel having a measurement inlet through which air flows in and a measurement outlet through which air flows out; a sensing portion that outputs a signal according to the flow rate of air in the measurement channel; and a measurement control unit that measures the air flow rate using the output value of the sensing portion and outputs the measurement result of the air flow rate to a predetermined external device. The measurement control unit includes: a pulsation state calculator that calculates a pulsation state that is a state of pulsation generated in the air flow rate using the output value, instead of acquiring an output value from an external device; and a flow rate correcting unit that corrects the air flow rate using the pulsation state calculated by the pulsation state calculator.

In the third aspect, a measurement control device measures an air flow rate using an output value of a sensing portion that outputs a signal according to a flow rate of air to be drawn into the internal combustion engine, and outputs the measurement result of the air flow rate to an external device. The measurement control device includes: a pulsation state calculator that calculates a pulsation state that is a state of pulsation generated in the air flow rate using the output value; a flow rate correcting unit that corrects the air flow rate using the pulsation state calculated by the pulsation state calculator, and a filter unit that removes a component of a predetermined cutoff frequency from a waveform that represents a time change of the output value. A rotation fluctuation frequency represents a frequency of a waveform representing a time change of the rotation speed of the internal combustion engine, and the cutoff frequency is set to a positive real number times the rotation fluctuation frequency.

### BRIEF DESCRIPTION OF DRAWINGS

FIG. 1 is a perspective view of an airflow meter according to a first embodiment viewed from an upstream side.

FIG. 2 is a perspective view of the airflow meter as seen from the downstream side.

FIG. 3 is a vertical cross-sectional view of the airflow meter attached to an intake pipe.

FIG. 4 is a cross-sectional view taken along a line IV-IV in FIG. 3.

FIG. 5 is a cross-sectional view taken along a line V-V in FIG. 3.

FIG. 6 is a block diagram illustrating a schematic configuration of the airflow meter.

FIG. 7 is a block diagram illustrating a schematic configuration of a correction circuit.

FIG. 8 is a diagram for explaining a method of calculating an interval between upper extremes.

FIG. 9 is a diagram for explaining a method of calculating an average of air flow rate.

FIG. 10 is a diagram for explaining a method of calculating a pulsation amplitude.

FIG. 11 is a diagram illustrating a relationship between pulsation characteristics and an approximate value.

FIG. 12 is a diagram illustrating a reference map.

FIG. 13 is a diagram for explaining a method of calculating a corrected value of the average of air flow rate.

FIG. 14 is a block diagram illustrating a schematic configuration of a correction circuit according to a second embodiment.

FIG. 15 is a diagram for illustrating noise included in an output value.

FIG. 16 is a diagram for explaining a method of cutting a minus value of the output value.

FIG. 17 is a block diagram illustrating a schematic configuration of a correction circuit according to a third embodiment.

FIG. 18 is a diagram for explaining a method of calculating an interval between lower extremes.

FIG. 19 is a block diagram illustrating a schematic configuration of a correction circuit according to a fourth embodiment.

FIG. 20 is a diagram for explaining a method of calculating an increase interval.

FIG. 21 is a block diagram illustrating a schematic configuration of a correction circuit according to a fifth embodiment.

FIG. 22 is a diagram for explaining a method of calculating a decrease interval.

FIG. 23 is a diagram for explaining a method of calculating a corrected value of an average of air flow rate in a sixth embodiment.

FIG. 24 is a vertical cross-sectional view of an airflow meter attached to an intake pipe in Modification 1.

FIG. 25 is a diagram illustrating a noise removal function when calculating an interval between upper extremes in a seventh embodiment.

FIG. 26 is a flowchart illustrating a processing for noise removal in the seventh embodiment.

FIG. 27 is a diagram for explaining a noise removal function when calculating an interval between lower extremes in an eighth embodiment.

FIG. 28 is a diagram for explaining a noise removal function when calculating an increase interval in a ninth embodiment.

FIG. 29 is a diagram for explaining a noise removal function when calculating a decrease interval in a tenth embodiment.

FIG. 30 is a diagram for explaining a noise removal function when calculating an interval between upper extremes in an eleventh embodiment.

FIG. 31 is a block diagram illustrating a schematic configuration of a correction circuit according to a twelfth embodiment.

FIG. 32 is a block diagram illustrating a schematic configuration of a correction circuit according to a thirteenth embodiment.

FIG. 33 is a flowchart illustrating a processing for calculation of frequency in a fourteenth embodiment.

FIG. 34 is a flowchart illustrating a processing for calculation of frequency in a fifteenth embodiment.

### DETAILED DESCRIPTION

To begin with, examples of relevant techniques will be described.

To measure an air flow rate, an ECU that controls an internal combustion engine calculates an air flow rate based on an output value of an air flow sensor. In addition to the detection signal of the air flow sensor, a detection signal of a crank angle sensor that detects the engine speed is input to the ECU. The ECU calculates a pulsation frequency of the air flow rate by using the engine speed detected by the crank angle sensor, and corrects the air flow rate using the pulsation frequency to reduce a pulsation error, which is an error caused by the pulsation of the air flow rate.

However, since the ECU performs the correction processing of the air flow rate in addition to the control processing of the internal combustion engine, it is assumed that the processing load of the ECU excessively increases. It is conceivable that a measurement control device independent of the ECU executes the correction processing of the air flow rate, and the measurement control device outputs the correction result of the air flow rate to the ECU. With this configuration, the ECU can obtain the correction result of the air flow rate, and further, the processing load on the ECU can be reduced. However, even in this configuration, if the measurement control device uses the engine speed for calculating the pulsation state such as the pulsation frequency, the ECU needs to output the rotation speed information indicating the engine speed to the measurement control device. As described above, when the measurement control device uses the rotation speed information from the ECU for the correction of the air flow rate, the correction accuracy of the air flow rate may be deteriorated due to noise included in the rotation speed information.

The present disclosure provides a measurement control device and a flow volume measuring device that can improve the correction accuracy of the air flow rate.

In the first aspect of the present disclosure, a measurement control device measures an air flow rate using an output value of a sensing portion that outputs a signal according to the air flow rate, and outputs the measurement result of the air flow rate to a predetermined external device. The measurement control device includes: a pulsation state calculator that calculates a pulsation state that is a state of pulsation generated in the air flow rate using an output value, instead of acquiring an output value from an external device; and a flow rate correcting unit that corrects the air flow rate using the pulsation state calculated by the pulsation state calculator.

According to the first aspect, the pulsation state obtained from the external device is not used for the correction of the air flow rate, but the pulsation state calculated by the pulsation state calculator using the output value of the sensing portion is used for the correction of the air flow rate. With this configuration, it is possible to restrict the correction accuracy of the air flow rate from being reduced due to the fact that the pulsation state acquired from the external device includes noise and the like. Therefore, the correction accuracy of the air flow rate by the flow rate correcting unit can be improved.

In the second aspect, a flow volume measuring device measures an air flow rate, and includes: a measurement channel having a measurement inlet through which air flows in and a measurement outlet through which air flows out; a sensing portion that outputs a signal according to the flow rate of air in the measurement channel; and a measurement control unit that measures the air flow rate using the output value of the sensing portion and outputs the measurement result of the air flow rate to a predetermined external device. The measurement control unit includes: a pulsation state calculator that calculates a pulsation state that is a state of pulsation generated in the air flow rate using the output value, instead of acquiring an output value from an external device; and a flow rate correcting unit that corrects the air flow rate using the pulsation state calculated by the pulsation state calculator.

According to the second aspect, the same effects as those of the first aspect can be achieved.

In the third aspect, a measurement control device measures an air flow rate using an output value of a sensing portion that outputs a signal according to a flow rate of air to be drawn into the internal combustion engine, and outputs the measurement result of the air flow rate to an external device. The measurement control device includes: a pulsation state calculator that calculates a pulsation state that is a state of pulsation generated in the air flow rate using the output value; a flow rate correcting unit that corrects the air flow rate using the pulsation state calculated by the pulsation state calculator, and a filter unit that removes a component of a predetermined cutoff frequency from a waveform that represents a time change of the output value. A rotation fluctuation frequency represents a frequency of a waveform representing a time change of the rotation speed of the internal combustion engine, and the cutoff frequency is set to a positive real number times the rotation fluctuation frequency.

According to the third aspect, the same effect as that of the first aspect can be obtained. Further, it is possible to further improve the correction accuracy of the air flow rate since the noise is removed at the cutoff frequency set to a positive real number multiple of the rotation fluctuation frequency.

Hereinafter, plural embodiments of the present disclosure will be described with reference to the drawings. Incidentally, the same reference numerals are assigned to the corresponding components in each embodiment, and thus, duplicate descriptions may be omitted. When only a part of the configuration is described in each embodiment, the configuration of the other embodiments described above can be applied to the other parts of the configuration. Further, not only the combinations of the configurations explicitly shown in the description of the respective embodiments, but also the configurations of the embodiments can be partially combined together even if the configurations are not explicitly shown if there is no problem in the combination in particular. Unspecified combinations of the configurations described in the embodiments and the modification examples are also disclosed in the following description.

### First Embodiment

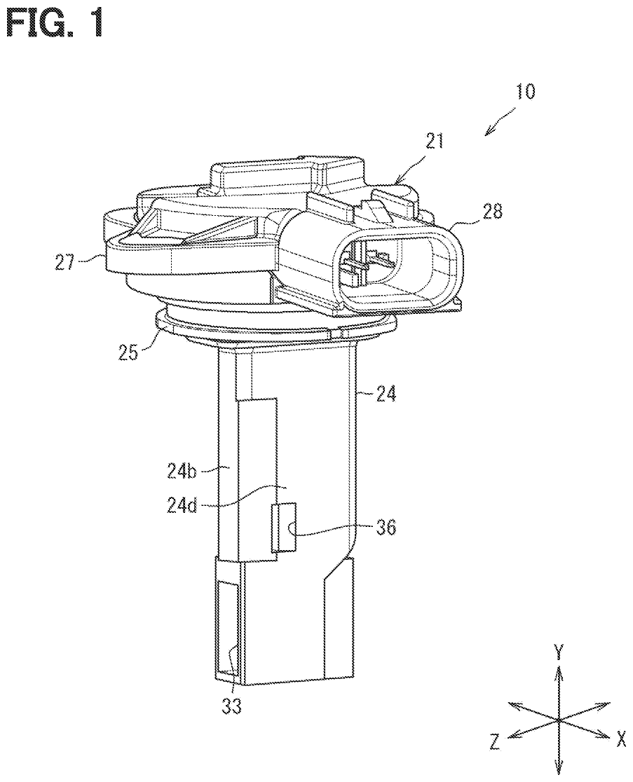

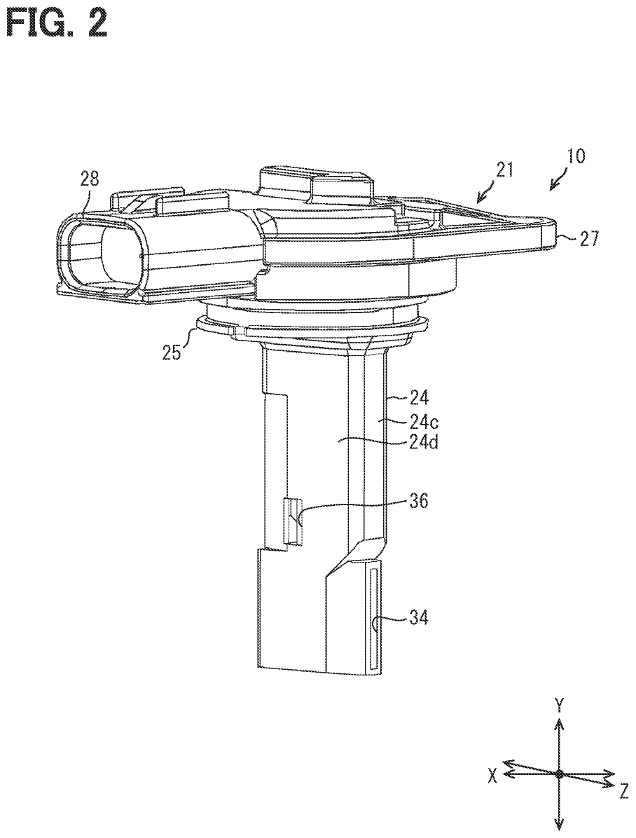

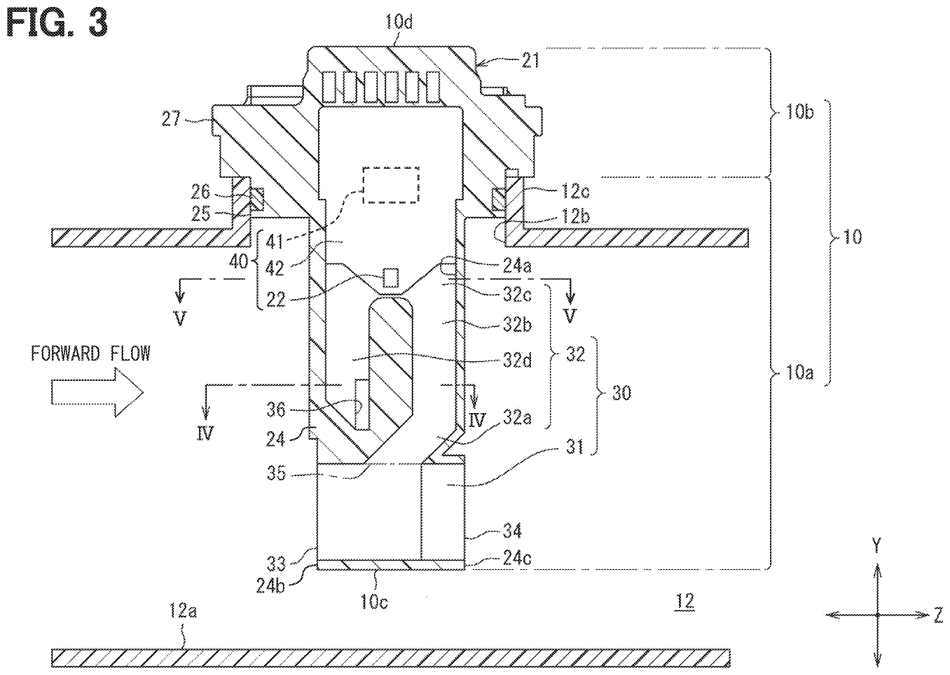

An airflow meter 10 shown in FIGS. 1 and 2 is included in a combustion system having an internal combustion engine such as a gasoline engine. The combustion system is mounted on a vehicle. As shown in FIG. 3, the airflow meter 10 is provided in an intake passage 12 for supplying an intake air to an internal combustion engine in a combustion system, and measures a physical quantity such as a flow rate, a temperature, a humidity, a pressure, and the like of fluid such as gas, e.g., intake air, flowing through the intake passage 12. In that case, the airflow meter 10 corresponds to a flow volume measuring device.

The airflow meter 10 is attached to an intake pipe 12a such as an intake duct that forms the intake passage 12. The intake pipe 12a has an insertion hole 12b as a through hole penetrating through an outer circumferential portion of the intake pipe 12a. An annular pipe flange 12c is attached to the insertion hole 12b, and the pipe flange 12c is included in the intake pipe 12a. The airflow meter 10 is inserted into the pipe flange 12c and the insertion hole 12b to enter the intake passage 12, and is fixed to the intake pipe 12a and the pipe flange 12c in this state.

In the present embodiment, a width direction X, a height direction Y, and a depth direction Z of the airflow meter 10 are orthogonal to each other. The airflow meter 10 extends in the height direction Y, and the intake passage 12 extends in the depth direction Z. The airflow meter 10 has an entering part 10a entering the intake passage 12 and a protruding part 10b protruding outside from the pipe flange 12c without entering the intake passage 12. The entering part 10a and the protruding part 10b are aligned in the height direction Y. The airflow meter 10 has a tip end face 10c included in the entering part 10a, and a base end face 10d included in the protruding part 10b. The tip end face 10c and the base end face 10d are aligned in the height direction Y. The tip end face 10c and the base end face 10d are orthogonal to the height direction Y. A tip end surface of the pipe flange 12c is also orthogonal to the height direction Y.

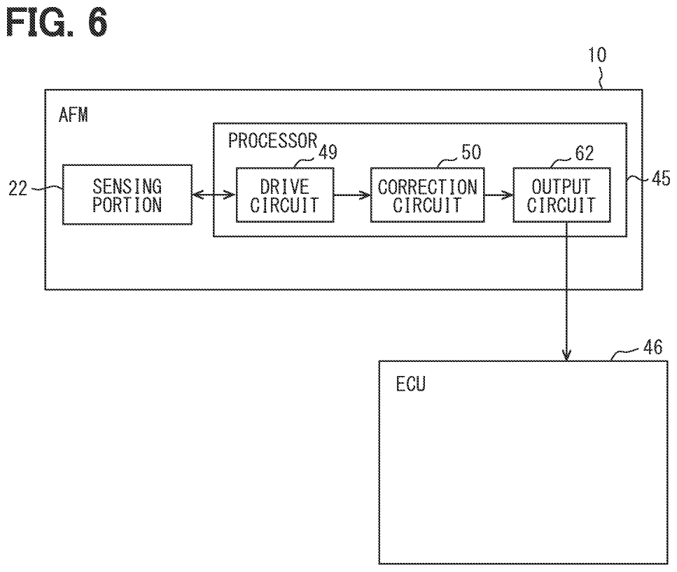

As shown in FIGS. 1 and 2, the airflow meter 10 has a housing 21, and a sensing portion 22 for detecting a flow rate of intake air (see FIGS. 3 and 6). The sensing portion 22 is provided in an internal space 24a of the housing body 24. The housing 21 is made of, for example, a resin material or the like. In the airflow meter 10, the housing 21 is attached to the intake pipe 12a so that the sensing portion 22 is brought into contact with the intake air flowing through the intake passage 12. The housing 21 has the housing body 24, a ring holding portion 25, a flange portion 27, and a connector portion 28. An O-ring 26 (see FIG. 3) is attached to the ring holding portion 25.

The housing body 24 is formed in a cylindrical shape as a whole, in the housing 21. The ring holding portion 25, the flange portion 27, and the connector portion 28 are integrally provided in the housing body 24. The ring holding portion 25 is included in the entering part 10a, and the flange portion 27 and the connector portion 28 are included in the protruding part 10b.

The ring holding portion 25 is provided inside the pipe flange 12c, and holds the O-ring 26 so as not to be displaced in the height direction Y. The O-ring 26 is a sealing member for sealing the intake passage 12 inside the pipe flange 12c, and is in close contact with both an outer peripheral surface of the ring holding portion 25 and an inner peripheral surface of the pipe flange 12c. A fixing hole such as a screw hole for fixing a fixing tool such as a screw for fixing the airflow meter 10 to the intake pipe 12a is provided in the flange portion 27. The connector portion 28 is a protection portion for protecting a connector terminal electrically connected to the sensing portion 22.

As shown in FIG. 3, the housing body 24 provides a bypass passage 30 through which a part of the intake air flowing through the intake passage 12 flows. The bypass passage 30 is disposed in the entering part 10a of the airflow meter 10. The bypass passage 30 has a flow channel 31 and a measurement channel 32, and the flow channel 31 and the measurement channel 32 are defined by the internal space 24a of the housing body 24. The intake passage 12 may be referred to as a main passage, and the bypass passage 30 may be referred to as a sub-passage. In FIG. 3, the O-ring 26 may not be shown.

The flow channel 31 penetrates through the housing body 24 in the depth direction Z. The flow channel 31 has an inflow port 33 as an upstream end portion and an outflow port 34 as a downstream end portion. The inflow port 33 and the outflow port 34 are aligned in the depth direction Z, and the depth direction Z corresponds to an alignment direction. The measurement channel 32 is a branch passage branched from an intermediate portion of the flow channel 31, and the sensing portion 22 is provided in the measurement channel 32. The measurement channel 32 has a measurement inlet 35 which is an upstream end portion of the measurement channel 32 and a measurement outlet 36 which is a downstream end portion of the measurement channel 32. A portion of the measurement channel 32 branched from the flow channel defines a boundary between the flow channel 31 and the measurement channel 32, and the measurement inlet 35 is included in the boundary. The measurement outlet 36 corresponds to a branch outlet.

The sensing portion 22 includes a circuit board and a detection element mounted on the circuit board, and is a chip-type flow sensor. The detection element has a heater section such as a heating resistor and a temperature detection section for detecting the temperature of the air heated by the heater section. The sensing portion 22 outputs a signal according to a change in the temperature due to heat generation in the detection element. The sensing portion 22 can also be referred to as a flow rate detection unit.

The airflow meter 10 has a sensor sub-assembly including the sensing portion 22. The sensor sub-assembly is referred to as a sensor SA 40. The sensor SA 40 is housed in the housing body 24. The sensor SA 40 has a circuit chip 41 electrically connected to the sensing portion 22, and a molding portion 42 that protects the sensing portion 22 and the circuit chip 41, in addition to the sensing portion 22. The circuit chip 41 is a rectangular parallelepiped component having a digital circuit that performs various processes. In the sensor SA 40, the sensing portion 22 and the circuit chip 41 are supported by a lead frame, and the circuit chip 41 is electrically connected to the sensing portion 22 and the lead frame via a bonding wire or the like.

The molding portion 42 is made of a mold resin such as a polymer resin formed by molding, and has a higher insulation property than the lead frame or the bonding wire. The molding portion 42 protects the circuit chip 41 and the sensing portion 22 in a state where the circuit chip 41, the bonding wire, and the like are sealed. In the sensor SA 40, the sensing portion 22 and the circuit chip 41 are mounted in one package by the molding portion 42. The sensor SA 40 corresponds to a sensing unit, and the molding portion 42 corresponds to a body. The sensor SA 40 may also be referred to as a detection unit or a sensor portion.

The sensing portion 22 outputs a signal corresponding to the air flow rate in the measurement channel 32 to the circuit chip. The circuit chip calculates the air flow rate using the signal output from the sensing portion 22. The calculation result of the circuit chip is the air flow rate measured by the airflow meter 10. The airflow meter 10 has an inflow port 33 and an outflow port 34 at the center position of the intake passage 12 in the height direction Y. The intake air flowing at the center position of the intake passage 12 in the height direction Y flows along the depth direction Z. The flow direction of the intake air flowing in the intake passage 12 substantially coincides with the flow direction of the intake air flowing in the flow channel 31. The sensing portion 22 is not limited to a thermal type flow rate sensor, and may be an ultrasonic type flow sensor, a Kalman vortex type flow sensor, or the like.

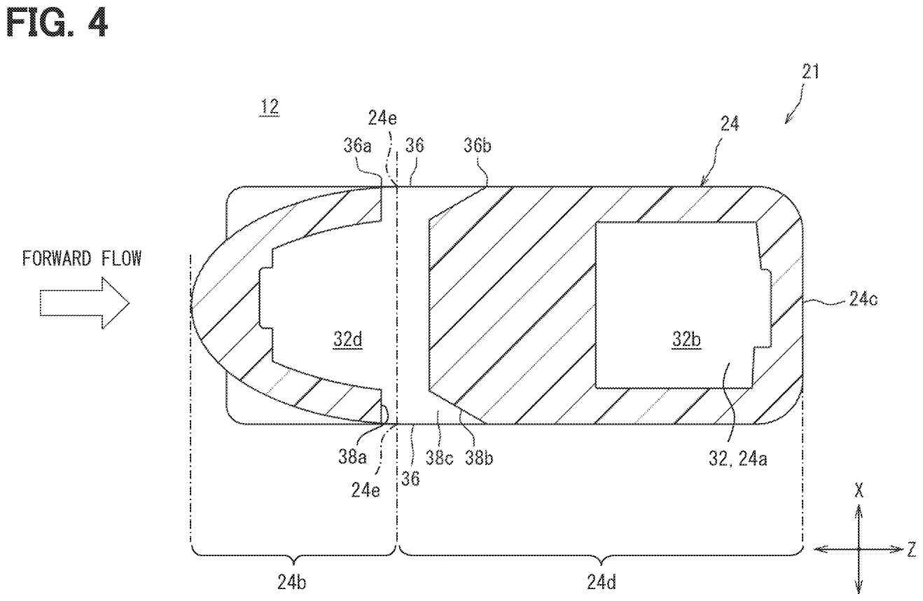

As shown in FIG. 4, an outer peripheral surface of the housing body 24 forming an outer peripheral surface of the housing 21 has an upstream outer surface 24b, a downstream outer surface 24c, and intermediate outer surfaces 24d. In the outer peripheral surface of the housing body 24, the upstream outer surface 24b faces the upstream side of the intake passage 12, and the downstream outer surface 24c faces the downstream side of the intake passage 12. The intermediate outer surfaces 24d face opposite sides in the width direction X, and are flat surfaces extending in the depth direction Z. The upstream outer surface 24b is inclined with respect to the intermediate outer surfaces 24d. In this case, the upstream outer surface 24b is an inclined surface curved so that a width dimension of the housing body 24 in the width direction X is gradually reduced toward the upstream side in the intake passage 12.

The intermediate outer surfaces 24d are provided between the upstream outer surface 24b and the downstream outer surface 24c in the depth direction Z. In this case, the upstream outer surface 24b and the intermediate outer surface 24d are aligned in the depth direction Z. A surface boundary 24e between the upstream outer surface 24b and the intermediate outer surface 24d extends in the height direction Y. The upstream outer surface 24b and the downstream outer surface 24c form end surfaces facing opposite to each other in the depth direction Z.

As shown in FIG. 3, the inflow port 33 is provided on the upstream outer surface 24b, and the outflow port 34 is provided on the downstream outer surface 24c. In this case, the inflow port 33 and the outflow port 34 are opened in opposite directions to each other. As shown in FIG. 4, the measurement outlet 36 is provided in both the upstream outer surface 24b and the intermediate outer surfaces 24d by being placed at a position across the surface boundary 24e in the depth direction Z. A part of the measurement outlet 36 located on the upstream outer surface 24b is opened toward the same side as the inflow port 33, and a part of the measurement outlet 36 located on the intermediate outer surface 24d is opened in the width direction X. In that case, the measurement outlet 36 is oriented to be inclined toward the inflow port 33 with respect to the width direction X. The measurement outlet 36 is not opened toward the outflow port 34. In other words, the measurement outlet 36 is not opened toward the downstream side in the intake passage 12.

The measurement outlet 36 has a vertically elongated flat shape extending along the surface boundary 24e. The measurement outlet 36 is disposed at a position closer to the intermediate outer surface 24d with respect to the surface boundary 24e in the depth direction Z. An area of the measurement outlet 36 disposed on the intermediate outer surfaces 24d is larger than an area of the measurement outlet 36 disposed on the upstream outer surface 24b. In this case, a separation distance between the downstream end of the measurement outlet 36 and the surface boundary 24e in the depth direction Z is larger than a separation distance between the upstream end of the measurement outlet 36 and the surface boundary 24e.

The inner peripheral surface of the measurement channel 32 has defining surfaces 38a to 38c that define the measurement outlet 36. A through hole for defining the measurement outlet 36 is provided in the outer peripheral portion of the housing body 24. The defining surfaces 38a to 38c are included in an inner peripheral surface of the through hole. Of the defining surfaces 38a to 38c, the upstream defining surface 38a forms an upstream end 36a of the measurement outlet 36, the downstream defining surface 38b forms a downstream end 36b of the measurement outlet 36. A connection defining surface 38c connects the upstream defining surface 38a and the downstream defining surface 38b, and is one of connection defining surfaces 38c interposed between the upstream defining surface 38a and the downstream defining surface 38b.

The upstream defining surface 38a is orthogonal to the depth direction Z, and extends in the width direction X from the upstream end 36a of the measurement outlet 36 into the housing body 24. The downstream defining surface 38b is inclined with respect to the depth direction Z, and is an inclined surface extending straight toward the upstream outer surface 24b from the downstream end 36b of the measurement outlet 36 into the housing body 24.

A flow of the intake air generated on the outer peripheral side of the housing body 24 in the intake passage 12 will be described in brief. Air flowing toward the downstream side of the intake passage 12 and reaching the upstream outer surface 24b of the housing body 24 advances along the upstream outer surface 24b which is an inclined surface to gradually change the flow direction of air and reaches the measurement outlet 36. Since the flow direction of the air is smoothly changed by the upstream outer surface 24b, a separation of the air is hardly generated in the vicinity of the measurement outlet 36. For that reason, the air flowing through the measurement channel 32 easily flows out of the measurement outlet 36, and the flow velocity in the measurement channel 32 is easily stabilized.

Further, the air flowing through the measurement channel 32 and flowing out of the measurement outlet 36 to the intake passage 12 flows along the downstream defining surface 38b, which is an inclined surface, so that the air easily flows toward the downstream side in the intake passage 12. In that case, when the air flowing out from the measurement outlet 36 along the downstream defining surface 38b joins the intake air flowing through the intake passage 12, a turbulence such as a vortex flow is less likely to occur in the air flow, so that the flow velocity in the measurement channel 32 is more likely to be stabilized.

As shown in FIG. 3, the measurement channel 32 has a folded shape folded between the measurement inlet 35 and the measurement outlet 36. The measurement channel 32 has a branch path 32a branched from the flow channel 31, a guide path 32b for guiding the air flowing from the branch path 32a toward the sensing portion 22, a detection path 32c where the sensing portion 22 is provided, and a discharge path 32d for discharging the air from the measurement outlet 36. The measurement channel 32 has the branch path 32a, the guide path 32b, the detection path 32c, and the discharge path 32d in this order from the upstream side.

The detection path 32c extends in the depth direction Z so as to be parallel to the flow channel 31, and is provided at a position separated from the flow channel 31 toward the protruding part 10b. The branch path 32a, the guide path 32b, and the discharge path 32d are provided between the detection path 32c and the flow channel 31. The guide path 32b and the discharge path 32d are parallel to each other by extending in the height direction Y from the detection path 32c toward the flow channel 31. The branch path 32a is provided between the guide path 32b and the flow channel 31, and corresponds to an inclined branch path inclined with respect to the flow channel 31. The branch path 32a extends from the measurement inlet 35 toward the outflow port 34 with respect to the depth direction Z, and is a straight passage. The discharge path 32d is provided closer to the inflow port 33 than the guide path 32b in the depth direction Z, and extends from the measurement outlet 36 toward the detection path 32c.

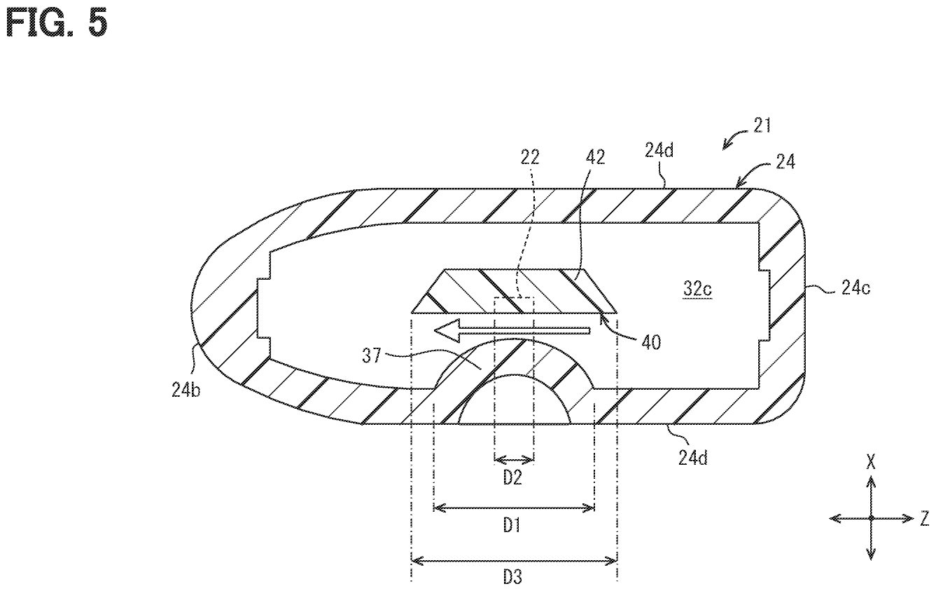

As shown in FIG. 5, the sensor SA 40 is arranged at a position where the sensing portion 22 enters the detection path 32c. The sensing portion 22 is arranged between the intermediate outer surfaces 24d in the width direction X, and extends in the depth direction Z and the height direction Y. The sensing portion 22 is provided such that the detection path 32c is partitioned in the width direction X.

The housing 21 has a detection throttle portion 37 that gradually narrows the detection path 32c toward the sensing portion 22 in the depth direction Z. The detection throttle portion 37 gradually reduces the cross-sectional area of the detection path 32c from the end of the detection path 32c adjacent to the downstream outer surface 24c toward the sensing portion 22. Further, the detection throttle portion 37 gradually reduces the cross-sectional area of the detection path 32c from the end of the detection path 32c adjacent to the upstream outer surface 24b toward the sensing portion 22. The cross-sectional area of the detection path 32c is defined as an area of the cross section orthogonal to the depth direction Z. When the air flows in the forward direction toward the sensing portion 22 through the detection path 32c, the detection throttle portion 37 can adjust the flow direction of air by gradually narrowing the detection path 32c, and corresponds to a rectifying mechanism. The detection throttle portion 37 corresponds to a throttle unit.

The detection throttle portion 37 is provided on the inner peripheral surface of the detection path 32c at a position facing the sensing portion 22. The detection throttle portion 37 projects from the inner peripheral surface of the housing body 24 toward the sensing portion 22. The depth dimension D1 of the detection throttle portion 37 in the depth direction Z is larger than the depth dimension D2 of the sensing portion 22 in the depth direction Z. Further, the depth dimension D3 of the molding portion 42 in the depth direction Z is larger than the depth dimension D1 of the detection throttle portion 37 in an area where the sensing portion 22 exists in the height direction Y.

The detection throttle portion 37 has a tapered shape in the width direction X. Specifically, a base portion of the detection throttle portion 37 protruding from the inner wall of the housing body 24 in the width direction X is the widest portion, and a tip end portion of the detection throttle portion 37 is the narrowest portion. The width dimension of the base portion of the detection throttle portion 37 is set to the depth dimension D1 described above. The detection throttle portion 37 has a curved surface that expands toward the sensing portion 22. The detection throttle portion 37 may have a tapered shape expanded toward the sensing portion 22.

An inner peripheral surface of the detection path 32c adjacent to the tip side of the housing is referred to as a bottom surface, and an inner peripheral surface of the detection path 32c adjacent to the base portion of the housing is referred to as a ceiling surface. The bottom surface of the detection path 32c is formed by the housing body 24, while the ceiling surface is formed by the sensor SA 40. The detection throttle portion 37 extends from the bottom surface of the detection path 32c toward the ceiling surface. The outer peripheral surface of the detection throttle portion 37 extends straight in the height direction Y.

In the detection path 32c, the distance between the molding portion 42 and the detection throttle section 37 gradually decreases as approaching the sensing portion 22 in the depth direction Z. With this configuration, when the intake air flowing from the guide path 32b into the detection path 32c passes between the molding portion 42 and the detection throttle portion 37, the flow velocity of the intake air tends to increase as approaching the sensing portion 22. In this case, since the intake air is applied to the sensing portion 22 at an appropriate flow rate, the output of the sensing portion 22 is easily stabilized and the detection accuracy can be improved.

When a pulsation occurs in the flow of intake air due to an operation state of the engine or the like in the intake passage 12, in addition to a forward flow flowing from the upstream side, the pulsation may cause a backward flow flowing from the downstream side in the opposite direction to the forward flow. Since the inflow port 33 is open toward the upstream side in the intake passage 12, a forward flow easily flows into the inflow port 33. Further, since the outflow port 34 is opened toward the downstream side, the backward flow is likely to flow into the outflow port 34. Further, since the measurement outlet 36 is not opened toward the downstream side in the intake passage 12, it is difficult for a backward flow to flow into the measurement outlet 36. Therefore, when the backward flow flows from the measurement outlet 36, the inflow state of the backward flow to the measurement outlet 36 is not stable, such that the air flow rate in the measurement channel 32 is likely to be unstable.

Unlike the present embodiment, for example, a part of the outer peripheral surface of the housing body 24 may be a step surface facing the downstream side. If the measurement outlet 36 is formed in the step surface, a turbulence such as vortex is likely to occur in the air passing along the step surface in the intake passage 12. In contrast, in the present embodiment, since the measurement outlet 36 is not formed in the step surface, the turbulence is unlikely to occur in the air flow around the measurement outlet 36. Therefore, the backward flow is restricted from being easily introduced into the measurement outlet 36. In this way, since unstable backflow is unlikely to occur in the measurement channel 32, stable pulsation measurement can be realized in the airflow meter 10.

As shown in FIG. 6, the airflow meter 10 has a processor 45 that processes the output signal of the sensing portion 22. The processor 45 is provided in the circuit chip 41 and is electrically connected to an ECU (Electronic Control Unit) 46. The ECU 46 corresponds to an internal combustion engine control device having a function of controlling the engine based on a measurement signal from the airflow meter 10. The measurement signal is an electric signal indicating the air flow rate corrected by a pulsation error correcting unit 61 described later. One-way communication is possible with the processor 45 and the ECU 46. While the signal input from the processor 45 to the ECU 46 is performed, the signal input from the ECU 46 to the processor 45 is not performed. The ECU 46 is provided independently of the processor 45 and the airflow meter 10, and corresponds to an external device.

The ECU 46 is electrically connected to engine sensors such as a crank angle sensor and a cam angle sensor. The ECU 46 acquires engine parameters such as a rotation angle, a rotation speed, and a rotation number of the engine using the detection signal of the engine sensor, and controls the engine using the engine parameters. The pulsation generated in the intake air in the intake passage 12 is correlated with the engine parameter. However, the ECU 46 of the present embodiment does not output the engine parameter to the processor 45. The processor 45 does not use the engine parameter when performing processing such as correction on the output signal of the sensing portion 22. The engine parameter corresponds to external information.

The sensing portion 22 outputs an output signal corresponding to the flow rate of air flowing through the measurement channel 32 to the processor 45. The output signal is an electric signal, a sensor signal, or a detection signal output from the sensing portion 22. An output value corresponding to a value of the air flow rate is included in the output signal. The sensing portion 22 is able to detect the air flow rate for both the air flowing in the forward direction from the measurement inlet 35 to the measurement outlet 36 and the air flowing in the reverse direction from the measurement outlet 36 to the measurement inlet 35 in the measurement channel 32. The output value of the sensing portion 22 is a positive value when the air is flowing in the measurement channel 32 in the forward direction, and is a negative value when the air is flowing in the reverse direction.

When a pulsation occurs in the air flow in the intake passage 12, the sensing portion 22 is affected by the pulsation, and an error is generated in the output value with respect to the true air flow rate. For example, the pulsation amplitude and the pulsation rate are likely to increase in the sensing portion 22 when a throttle valve is operated to a fully open side. Hereinafter, the error due to the pulsation is also referred to as pulsation error Err. The true air flow rate is an air flow rate that is not affected by pulsation. The pulsation rate is a value obtained by dividing the pulsation amplitude by the average value.

The processor 45 detects the air flow rate based on the output value of the sensing portion 22, and outputs the detected air flow rate to the ECU 46. The processor 45 includes a drive circuit 49 that drives the heater section of the sensing portion 22, a correction circuit 50 that corrects the output value of the sensing portion 22, and an output circuit 62 that outputs the correction result of the correction circuit 50 to the ECU 46. The drive circuit 49 supplies electric power to the sensing portion 22 for driving the heater section in addition to controlling the heater section. Further, the drive circuit 49 performs preprocessing such as amplifying the output signal of the sensing portion 22 before the correction circuit 50 performs the correction processing.

The processor 45 corresponds to a measurement control device and a measurement control unit that measure the air flow rate. The processor 45 includes an arithmetic processor such as a CPU, and a storage device for storing program and data. For example, the processor 45 is realized by a microcomputer having a storage device readable by a computer. The processor 45 performs various calculations by the arithmetic processor executing a program stored in the storage device to calculate the air flow rate, and outputs the calculated air flow rate to the ECU 46.

The storage device is a non-transitory tangible storage medium for non-transitory storage of computer readable programs and data. The storage medium is realized by a semiconductor memory or the like. The storage device can also be referred to as a storage medium. The processor 45 may include a volatile memory for temporarily storing data.

The processor 45 has a function of correcting the output value in which the pulsation error Err occurs. In other words, the processor 45 corrects the air flow rate of the output signal so as to approach the true air flow rate. Therefore, the processor 45 corrects the pulsation error Err, and outputs the corrected air flow rate to the ECU 46 as a measurement signal. The measurement signal includes a measurement value that is the correction result of the output value.

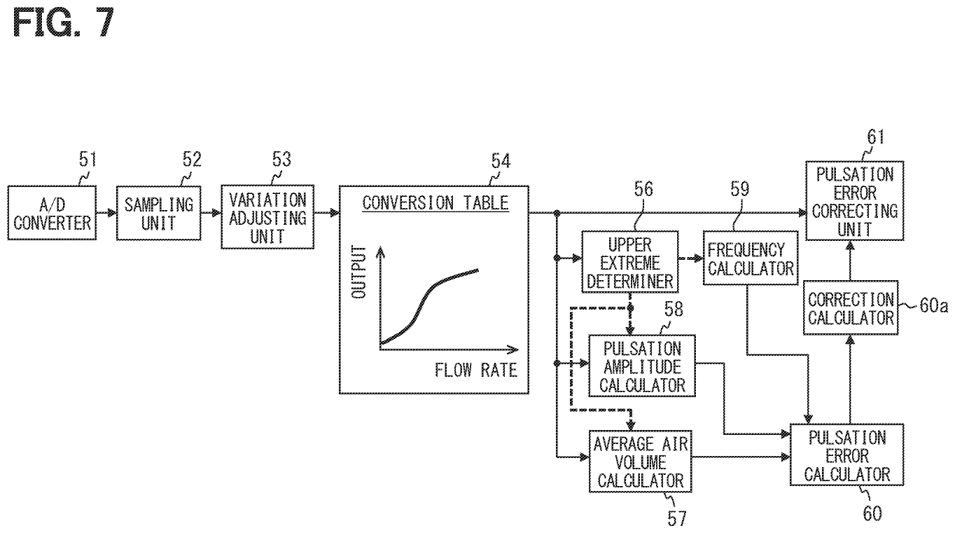

The processor 45 operates as multiple functional blocks by executing the program. The drive circuit 49, the correction circuit 50, and the output circuit 62 are all functional blocks. As shown in FIG. 7, the correction circuit 50 has, as functional blocks, an A/D converter 51, a sampling unit 52, a variation adjusting unit 53, and a conversion table 54.

The A/D converter 51 performs A/D conversion on the output value from the sensing portion 22 to the correction circuit 50 via the drive circuit 49. The sampling unit 52 samples the A/D converted output value and acquires the sampled value at each timing. The sampling values are included in the output value. The variation adjusting unit 53 adjusts the variation of the output value of the sensing portion 22 so that the measurement value does not vary due to the individual difference of the airflow meter 10 such as the individual difference of the sensing portion 22. Specifically, the variation adjusting unit 53 reduces individual variation in the flow rate output characteristic indicating the relationship between the output value and the actual air flow rate and the temperature characteristic indicating the relationship between the flow rate output characteristic and the temperature.

The conversion table 54 converts the sampling value acquired by the sampling unit 52 into an air flow rate. In the present embodiment, the value converted by the conversion table 54 may be referred to as a sampling value or an output value, instead of the air flow rate. The conversion table 54 is created by using the flow rate output characteristics.

The correction circuit 50 includes, as functional blocks, an upper extreme determiner 56, an average air volume calculator 57, a pulsation amplitude calculator 58, a frequency calculator 59, a pulsation error calculator 60, a correction calculator 60a, and a pulsation error correcting unit 61.

The upper extreme determiner 56 determines whether the sampling value converted by the conversion table 54 is the upper extreme Ea. The upper extreme Ea is a sampling value at the timing when the output value changes from increasing to decreasing. The upper extreme determiner 56 acquires the timing at which the sampling value reaches the upper extreme Ea as the upper extreme timing ta, and stores the upper extreme timing ta in the storage device of the processor 45. Then, the upper extreme determiner 56 outputs information including the upper extreme timing ta to the average air volume calculator 57, the pulsation amplitude calculator 58, and the frequency calculator 59 as timing information indicating the pulsation cycle. In FIG. 7, the output of information regarding the output value of the sensing portion 22 is shown by a solid line, and the output of timing information is shown by a broken line. The fact that the output value becomes the upper extreme Ea corresponds to a predetermined specific condition. The upper extreme determiner 56 corresponds to a condition determiner, and the upper extreme timing ta corresponds to a timing when the output value corresponds to the specific condition.

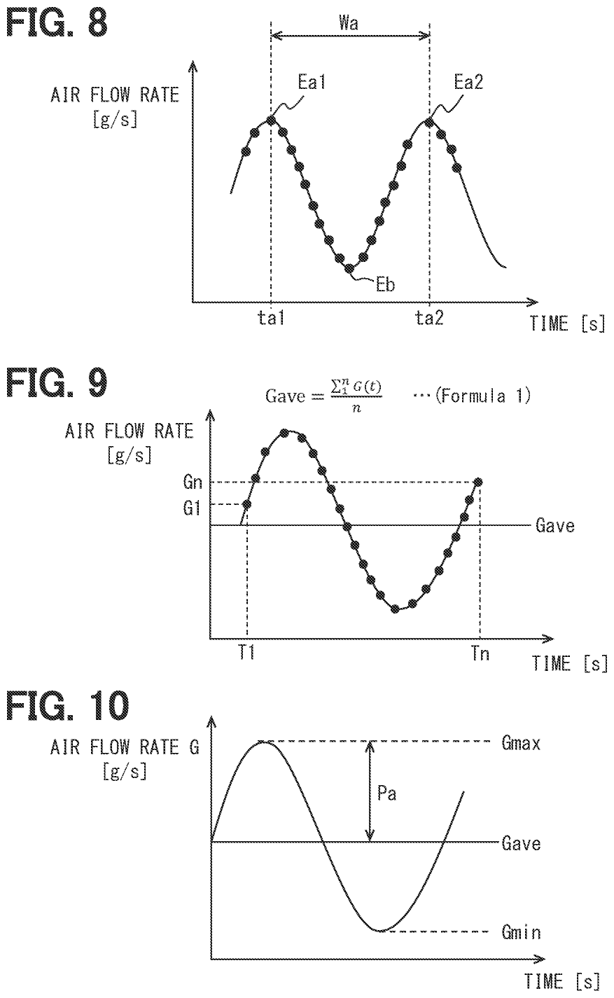

The frequency calculator 59 uses the timing information from the upper extreme determiner 56 to calculate the interval between which the sampling value becomes the upper extreme Ea as an upper extreme interval Wa, and calculates the pulsation frequency Fa using the upper extreme interval Wa. For example, as shown in FIG. 8, after the sampling value becomes the upper extreme Ea, the sampling value becomes the upper extreme Ea again. The previous upper extreme Ea is set as a first upper extreme Ea1. The next upper extreme Ea is referred to as a second upper extreme Ea2. The frequency calculator 59 uses the first upper extreme timing ta1 at which the sampling value becomes the first upper extreme Ea1 and the second upper extreme timing ta2 at which the sampling value becomes the second upper extreme Ea2 to calculate the upper extreme interval Wa between the upper extreme timings ta1 and ta2. Then, for example, the pulsation frequency F is calculated using the relationship of F [Hz]=1/Wa [s]. The upper extreme interval Wa corresponds to a time interval.

During the period from the first upper extreme timing ta1 to the second upper extreme timing ta2, the pulsation maximum value Gmax (see FIG. 10), which is the maximum value of the air flow rate when the air is pulsating, is larger one of the first upper extreme Ea1 or the second upper extreme Ea2. When the upper extremes Ea1 and Ea2 are the same value, the value is the pulsation maximum value Gmax. The average value of the first upper extreme Ea1 and the second upper extreme Ea2 may be the pulsation maximum value Gmax.

A lower extreme Eb which is a sampling value at the timing when the output value switches from decreasing to increasing exists between the first upper extreme Ea1 and the second upper extreme Ea2. Since there is only one lower extreme Eb between the first upper extreme timing ta1 and the second upper extreme timing ta2, the lower extreme Eb becomes the pulsation minimum value Gmin (see FIG. 10).

The average air volume calculator 57 uses the sampling value converted by the conversion table 54 and the timing information from the upper extreme determiner 56 to calculate the average air volume Gave (see FIG. 10) that is an average value of the air flow rate. The average air volume calculator 57 sets a target period for calculating the average air volume Gave as a measurement period using the determination result of the upper extreme determiner 56, and calculates the average air volume Gave for this measurement period. For example, in FIG. 8, when the period from the first upper extreme timing ta1 to the second upper extreme timing ta2 is set as the measurement period, the average air volume Gave is calculated for this measurement period.

The average air volume calculator 57 calculates the average air volume Gave by use of, for example, an integrated average. For example, the calculation of the average air volume Gave will be described with reference to a waveform shown in FIG. 9. In this example, a period from the timing t1 to the timing tn is set as the measurement period. The air flow rate at the timing t1 is G1, and the air flow rate at the timing tn is Gn. The average air volume calculator 57 calculates the average air volume Gave by use of Formula 1 in FIG. 9. In that case, the average air volume Gave can be calculated by reducing the influence of the pulsation minimum value Gmin whose detection accuracy is relatively lower, when the number of samples is larger as compared with a case in which the number of samples is smaller.

In the measurement channel 32, if the actual air flow rate is sufficiently large, the streamline of air is less likely to fluctuate when the air travels toward the measurement outlet 36, and the flow direction and the flow rate of the air passing through the sensing portion 22 are likely to be stable. For this reason, the detection accuracy of the sensing portion 22 tends to increase when the actual air flow rate is sufficiently high. The flow direction and the flow rate of the air passing through the sensing portion 22 are likely to be unstable when the actual air flow rate is smaller. For example, when the actual air flow rate in the measurement channel 32 is the smallest while no backflow occurs, the flow direction and the flow rate of air are not stable since the air moves by meandering toward the measurement outlet 36. Therefore, the detection accuracy of the sensing portion 22 is likely to decrease as the actual air flow rate decreases. Therefore, the detection accuracy of the sensing portion 22 becomes relatively low in the pulsation minimum value Gmin, among the output values.

The pulsation amplitude calculator 58 uses the sampling value converted by the conversion table 54 and the timing information from the upper extreme determiner 56 to calculate the pulsation amplitude Pa that is the magnitude of the pulsation generated in the air flow rate. The pulsation amplitude calculator 58 calculates the pulsation amplitude Pa for the measurement period. As shown in FIG. 10, the pulsation amplitude calculator 58 calculates the pulsation amplitude Pa of the air flow rate by using the difference between the pulsation maximum value Gmax and the average air volume Gave. In other words, the pulsation amplitude calculator 58 obtains not a total amplitude of the air flow but a half amplitude of the air flow, to reduce the influence of the pulsation minimum value Gmin whose detection accuracy is relatively low. The pulsation amplitude calculator 58 may calculate the total amplitude, which is a difference between the pulsation maximum value Gmax and the pulsation minimum value, as the pulsation amplitude.

Regarding the output values of the sensing portion 22, the upper extreme Ea, the pulsation frequency F, the pulsation amplitude Pa, and the average air volume Gave indicate the pulsation state that is a state of pulsation, and correspond to pulsation parameters. In this case, the upper extreme determiner 56, the average air volume calculator 57, the pulsation amplitude calculator 58, and the frequency calculator 59 correspond to a pulsation state calculator that calculates the pulsation state.

The pulsation error calculator 60 calculates the pulsation error Err of the air flow correlated with the pulsation amplitude Pa. The pulsation error calculator 60 predicts the pulsation error Err of the air flow by use of, for example, a map in which the pulsation amplitude Pa and the pulsation error Err are associated with each other. In other words, when the pulsation amplitude Pa is obtained by the pulsation amplitude calculator 58, the pulsation error calculator 60 extracts the pulsation error Err correlated with the obtained pulsation amplitude Pa from the map. It can be said that the pulsation error calculator 60 acquires the pulsation error Err correlated with the pulsation amplitude Pa for the measurement period. The pulsation error calculator 60 corresponds to an error calculator.

As described above, the airflow meter 10 is attached to the intake pipe 12a defining the intake passage 12. Therefore, in the airflow meter 10, depending on the shape of the intake pipe 12a, as the pulsation amplitude Pa increases, not only the pulsation error Err increases, but also the pulsation error Err may decrease. For that reason, in some cases, a relationship between the pulsation amplitude Pa and the pulsation error Err may not be able to be expressed by a function in the airflow meter 10. An accurate pulsation error Err can be predicted by use of the above-described map, preferable for the airflow meter 10. In the map, the multiple pulsation amplitudes Pa may be associated with a correction amount Q correlated with the respective pulsation amplitude Pa.

However, in some cases, the relationship between the pulsation amplitude Pa and the pulsation error Err can be expressed by a function, for example, when the sensing portion 22 of the airflow meter 10 is directly disposed in a main air passage. In that case, the airflow meter 10 may calculate the pulsation error Err by use of this function. Since the airflow meter 10 does not need to have a map when calculating the pulsation error Err by use of the function, a capacity of the storage device can be reduced. This also applies to the following embodiments. In other words, the pulsation error Err may be obtained by use of a function instead of the map in the following embodiment.

The pulsation error Err is a difference between the uncorrected air flow obtained by the output value and the true air flow. In other words, the pulsation error Err corresponds to a difference between the air flow in which the output value is converted by the conversion table 54 and the true air flow. Therefore, the correction amount Q can be obtained if the pulsation error Err is known for bringing the uncorrected air flow closer to the true air flow.

As shown in FIG. 7, the average air volume Gave calculated by the average air volume calculator 57, the pulsation amplitude Pa calculated by the pulsation amplitude calculator 58, and the pulsation frequency F calculated by the frequency calculator 59 are input to the pulsation error calculator 60. The pulsation error calculator 60 calculates the pulsation error Err by use of the average air volume Gave, the pulsation amplitude Pa, and the pulsation frequency F.

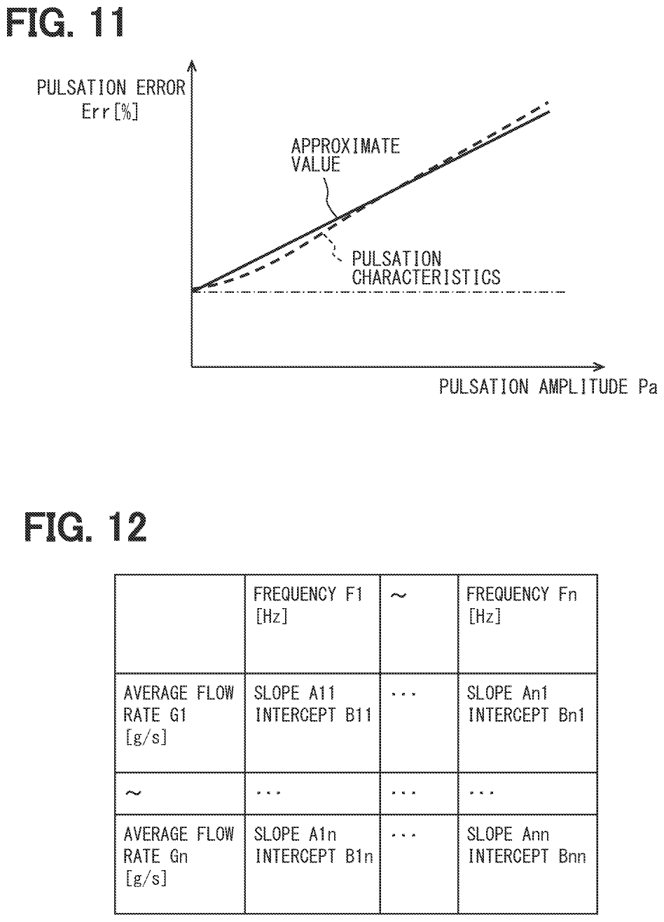

When pulsation occurs in the air flow, the pulsation amplitude Pa is likely to increase as the average air volume Gave increases. As shown in FIG. 11, an approximate line of the pulsation characteristics is shown by a straight line, when the pulsation amplitude Pa and the pulsation error Err are in a substantially proportional relationship in the pulsation characteristic indicating the relationship between the pulsation amplitude Pa and the pulsation error Err.

Err=Ann×Pa+Bnn (Formula 2)

The approximate line of the pulsation characteristic satisfies a relationship of Formula 2. In this relational expression, the pulsation error Err is predicted by use of the pulsation amplitude Pa. In the error prediction expression, Ann is a slope of the approximate line, and Bnn is an intercept. In the pulsation characteristic, the pulsation error Err corresponds to a correction parameter. The approximate line of the pulsation characteristic may be shown by a curve. In this case, the expression indicating the approximate line of the pulsation characteristic includes at least quadratic function or cubic or more functions.

The pulsation characteristic is set for each combination between the average air volume Gave and the pulsation frequency F. In FIG. 12, the slope Ann and the intercept Bnn indicating the pulsation characteristic are set in the respective windows indicating the combinations of the average air volume Gave and the pulsation frequency F. When such a map indicating a relationship between the average air volume Gave and the pulsation frequency F and the pulsation characteristics is referred to as a reference map, the reference map is a two-dimensional map and is stored in the storage device of the processor 45. In the reference map, the pulsation characteristic is set to a predetermined value for each of the average air volume Gave and the pulsation frequency F. The reference map may be a three-dimensional map or a four-dimensional map. For example, a three-dimensional map showing the relationship among the average air volume Gave, the pulsation frequency F, and the pulsation amplitude Pa may be used as the reference map.

In FIG. 12, the average air volume Gave set in the reference map is indicated as map values G1 to Gn, and the pulsation frequency F is indicated as map values of F1 to Fn. The pulsation characteristic corresponds to a correction characteristic, and the reference map corresponds to reference information. The reference map may be referred to as a correction map, and the reference information may be referred to as correction information.

The reference map can be created by confirming the relationship between the pulsation amplitude Pa and the pulsation error Err correlated with the pulsation amplitude Pa by experiments using an actual device or simulations. In other words, the pulsation error Err is a value obtained for each pulsation amplitude Pa when experiments using an actual device or simulations are performed by changing the value of the pulsation amplitude Pa. The other maps in the embodiment can be created by experiments using an actual device or simulations, similarly to the reference map.

The correction calculator 60a calculates the correction amount Q using the pulsation error Err calculated by the pulsation error calculator 60. The correction calculator 60a calculates the correction amount Q by using the correlation information such as a map showing the correlation between the pulsation error Err and the correction amount Q, for the measurement period. The correction amount Q is a value indicating a ratio of correction to the output value. For example, when the output value is corrected to increase the air flow rate, the correction amount Q is a value larger than 1. When the output value is corrected to decrease the air flow rate, the correction amount Q is smaller than 1. Note that the ratio of correction can also be called a gain.

The pulsation error correcting unit 61 corrects the air flow rate so that the pulsation error Err becomes smaller by using the sampling value converted by the conversion table 54 and the correction amount Q calculated by the correction calculator 60a. In other words, the pulsation error correcting unit 61 corrects the air flow rate affected by the pulsation to approach the true air flow rate. The average air volume Gave is adopted as an object to be corrected for the air flow rate.

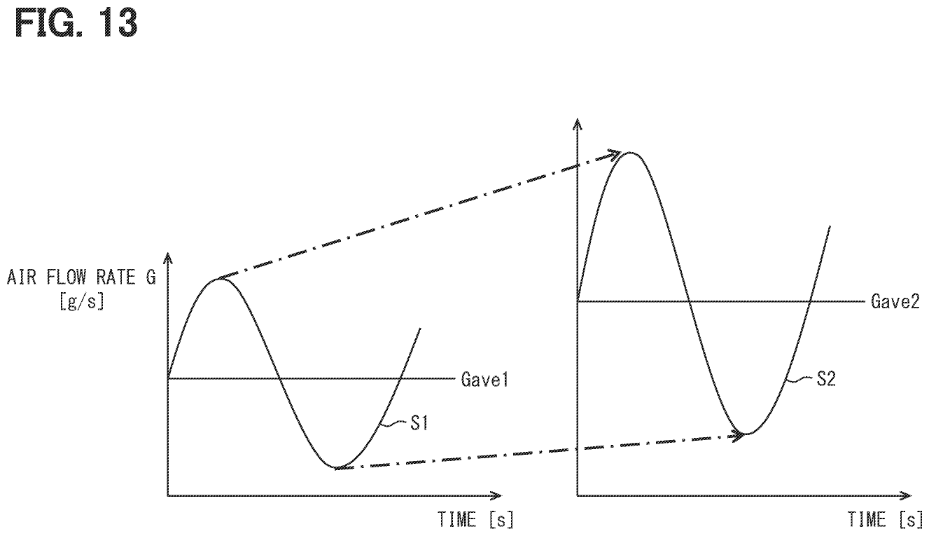

The pulsation error correcting unit 61 corrects the uncorrected output value S1 with the correction amount Q to calculate the corrected output value S2. In the present embodiment, the corrected output value S2 is calculated by multiplying the uncorrected output value S1 by the correction amount Q. In this case, the relationship of S2=S1×Q is established. For example, when the correction amount Q is larger than 1, as shown in FIG. 13, the corrected output value S2 becomes larger than the uncorrected output value S1. The pulsation error correcting unit 61 performs the calculation for the measurement period, and the uncorrected output value S1 includes at least the upper extreme Ea and the lower extreme Eb. The corrected output value S2 corresponds to the measurement result of the air flow rate. Further, the pulsation error correcting unit 61 corresponds to a flow rate correcting unit.

The correction circuit 50 outputs the corrected output value S2 calculated by the pulsation error correcting unit 61 to the output circuit 62. The output circuit 62 outputs the corrected output value S2 to the ECU 46. The ECU 46 uses the corrected output value S2 input from the output circuit 62 to calculate the average value of the corrected output value S2 as the corrected average air volume Gave2. For example, when the correction amount Q is larger than 1, as shown in FIG. 13, the corrected average air volume Gave2 becomes larger than the uncorrected average air volume Gave1.

According to the present embodiment, the correction circuit 50 does not use the engine parameter acquired by the ECU 46 for the correction of the air flow rate, but the correction circuit 50 uses the pulsation state such as the pulsation frequency F calculated using the output value of the sensing portion 22. With this configuration, it is possible to restrict the correction accuracy of the air flow rate from being deteriorated by noise included in the engine parameter. Therefore, the correction accuracy of the air flow rate by the correction circuit 50 can be improved.

Further, in this configuration, the processor 45 does not need to receive the signal output from the ECU 46. Therefore, the processor 45 only needs to have a circuit and a program for one-way communication, and does not need to have a circuit and a program for two-way communication. Therefore, it is possible to reduce the storage capacity of the memory, reduce the cost of the processor 45, and simplify the configuration of the processor 45 by the circuits and programs for performing bidirectional communication.

Further, since the processing for calculating the pulsation state such as the pulsation frequency F is performed by the processor 45 of the airflow meter 10 instead of the ECU 46, the processing load on the ECU 46 can be reduced. Further, the processing load on the ECU 46 is reduced since the ECU 46 does not output a signal to the processor 45. From these facts, it is not necessary to mount a memory for storing a program for calculating the pulsation state, and a temporary memory for temporarily storing data used during calculation in the ECU 46, so that the capacity can be reduced for the memory of the ECU 46.

When the processor 45 receives a signal including information such as an engine parameter from the ECU 46, a time delay occurs by the time required for communication. At the timing when the processor 45 receives a signal from the ECU 46, the information included in this signal is already past information for a very short time. When the processor 45 uses this information to correct the air flow rate, the current air flow rate will be corrected with past information. That is, the correction result of the air flow rate includes the correction delay, and there is a concern that the correction accuracy is lowered by the correction delay. In contrast, according to the present embodiment, since the processor 45 does not use the information from the ECU 46 for correcting the air flow rate, it is possible to suppress the correction accuracy from being lowered by the time delay or the correction delay.

According to the present embodiment, the pulsation error correcting unit 61 calculates the corrected output value as the measurement result using the uncorrected output value S1 and the correction amount Q. In this configuration, since all the output values S1 are corrected during the measurement period, the calculation accuracy of the corrected output value S2 and the calculation accuracy of the corrected average air volume Gave2 calculated by the ECU 46 are improved. Unlike the present embodiment, the corrected average air volume Gave2 may be made smaller than the uncorrected average air volume Gave1, for example, by deleting all the uncorrected output value S1 larger than a predetermined reference value. In this case, the output values S1 larger than the reference value do not contribute to the corrected average air volume Gave2. There is a concern that the calculation accuracy of the corrected average air volume Gave2 will decrease, for example, when the detection accuracy of the output value S1 larger than the reference value is relatively high.

According to this embodiment, the pulsation frequency F of the pulsation parameters is calculated using the output value of the sensing portion 22. In this case, it is possible to restrict the calculation accuracy of the pulsation frequency F from being lowered when noise is included in the engine parameter, compared with a case where the pulsation frequency F is calculated using the engine parameter. If the pulsation frequency F is calculated using the engine parameter, the pulsation frequency F is susceptible to the noise in the engine parameter among the pulsation parameters. Therefore, the calculation accuracy of the pulsation frequency F is effectively increased by calculating the pulsation frequency F without using the engine parameter from the ECU 46. Further, the correction value can be determined based on the pulsation frequency F in the circuit of the airflow meter 10. As a result, the correction accuracy can be improved.

The pulsation generated in the intake air in the intake passage 12 and the engine speed may be different. For example, intake air may have main pulsation which is n times of the engine speed due to the influence of the intake system, intake valve, and the like. For this reason, when correcting the air flow rate using the engine parameter, the pulsation error correcting unit 61 needs to n-times multiply the engine speed to correct the air flow rate. In contrast, according to the present embodiment, the frequency calculator 59 can calculate the pulsation frequency F corresponding to n times of the engine speed by using the output value of the sensing portion 22. Therefore, the pulsation error correcting unit 61 can improve the correction accuracy when correcting the air flow rate using the pulsation frequency F.

According to the present embodiment, the pulsation frequency F is calculated using the upper extreme interval Wa between the first upper extreme timing ta1 at which the output value becomes the first upper extreme Ea1 and the second upper extreme timing ta2 at which the output value becomes the second upper extreme Ea2. In this configuration, the upper extreme determiner 56 can calculate the upper extreme interval Wa by reading the two upper extreme timings ta1 and ta2 from the storage device storing the upper extreme timing to corresponding to the upper extreme Ea during the measurement period. In this case, since it is not necessary to store the timings corresponding to all the output values in the measurement period in the storage device, it is possible to reduce the capacity and the size of the storage device.

Further, in this configuration, the pulsation frequency F can be obtained by calculating the reciprocal of the upper extreme interval Wa. Therefore, it is not necessary to use a function or a map when calculating the pulsation frequency F, compared with a case where the pulsation frequency F is calculated using, for example, the change rate or the change mode of the output value. Since it is not necessary to store these functions and maps in the storage device, the storage device can be more reliably reduced in the capacity and the size.

Furthermore, the upper extreme interval Wa and the pulsation frequency F can be calculated with the upper extreme Ea that switches from increasing to decreasing while the output value increases/decreases with the pulsation. For example, unlike the present embodiment, the pulsation frequency F may be calculated using an interval of the timings at which the output value exceeds a predetermined threshold while the output value is increasing. However, in this case, there is concern that the calculation accuracy of the pulsation frequency F may be low if the output value repeats the increase and decrease within an area smaller than the threshold. In contrast, according to the present embodiment, the pulsation frequency F is calculated using the determination result of whether or not the output value has reached the upper extreme Ea. The calculation accuracy of the pulsation frequency F can be improved irrespective of the magnitude of the output value.

In addition, the calculation parameter used to calculate the pulsation frequency F is the upper extreme Ea. As described above, the detection accuracy of the output value by the sensing portion 22 is high when the actual air flow rate in the measurement channel 32 is sufficiently high. Therefore, according to the present embodiment, the calculation accuracy of the pulsation frequency F can be increased, since the upper extreme Ea, which has higher detection accuracy than the lower extreme Eb, is used as the calculation parameter.

According to this embodiment, the measurement channel 32 provided with the sensing portion 22 is a branched passage branched from the flow channel 31. If a foreign matter such as dust flows into the flow channel 31 from the inflow port 33 together with the air, the foreign matter does not easily enter the measurement channel 32 from the measurement inlet 35 but easily flows out to the outside from the outflow port 34. In this case, the bypass passage 30 has a foreign matter separation function of separating foreign matter from the air flowing into the measurement channel 32. Therefore, it is possible to restrict foreign matter from adhering to the sensing portion 22 in the measurement channel 32. The pulsation detected by the sensing portion 22 can be restricted from being affected by the foreign matter, such that the correction circuit 50 can avoid erroneous correction. That is, it is possible to restrict the correction accuracy of the pulsation error correcting unit 61 from being deteriorated due to the adhesion of the foreign matter to the sensing portion 22.

According to the present embodiment, the measurement channel 32 is gradually narrowed by the detection throttle portion 37 from the measurement inlet 35 toward the sensing portion 22. In this configuration, the air flowing from the measurement inlet 35 toward the sensing portion 22 in the measurement channel 32 is rectified by the detection throttle portion 37, so that the flow of air reaching the sensing portion 22 is unlikely to be disturbed. That is, the output of the sensing portion 22 can be stabilized. Therefore, it is possible to restrict the pulsation waveform detected by the sensing portion 22 from being distorted, resulting in an erroneous detection of the upper extreme Ea. The correction circuit 50 is restricted from having an error in the correction of the pulsation frequency F. That is, it is possible to restrict the correction accuracy of the pulsation error correcting unit 61 from being deteriorated due to the unstable air reaching the sensing portion 22.

According to the present embodiment, the sensor SA 40 includes the circuit chip 41 having the processor 45, the sensing portion 22, and the molding portion 42 protecting the circuit chip 41 and the sensing portion 22. The circuit chip 41 and the sensing portion 22 are packaged in one package by the molding portion 42. With this configuration, since the wirings such as bonding wires that connects the circuit chip 41 and the sensing portion 22 can be shortened, it is possible to reduce the electrical noise in the signal input from the sensing portion 22 to the processor 45. Therefore, the correction circuit 50 can be restricted from erroneously detecting noise as a pulsation amplitude in the pulsation frequency F and from erroneously correcting the pulsation frequency F due to the noise in the pulsation waveform to cause an error in the detection of the upper extreme Ea. Further, it is possible to reduce the size and the cost of the sensor SA 40 by packaging the circuit chip 41 and the sensing portion 22 in one package.

### Second Embodiment

In the first embodiment, the correction circuit 50 is provided with only one path for inputting the output value of the sensing portion 22 to the pulsation amplitude calculator 58. In the second embodiment, the correction circuit 50 is provided with two paths for inputting the output value to the pulsation amplitude calculator 58. In the present embodiment, differences from the first embodiment will be mainly described.

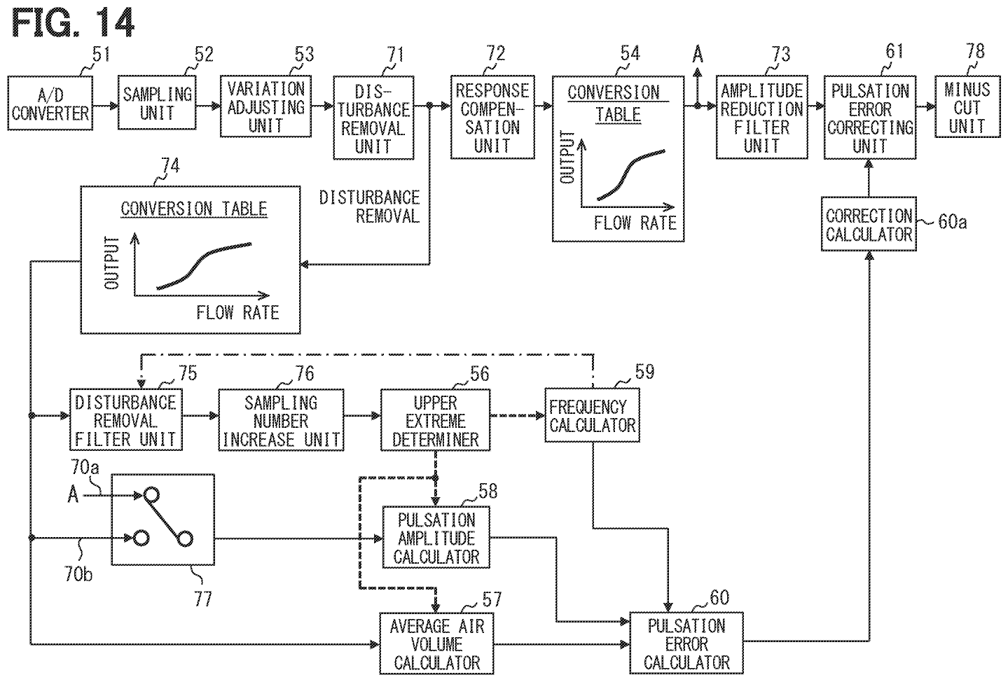

As shown in FIG. 14, the correction circuit 50 has the first path 70a for inputting the output value converted by the conversion table 54 to the pulsation amplitude calculator 58, and the second path 70b through which the output value that is not converted by the conversion table 54 is input to the pulsation amplitude calculator 58. In FIG. 14, a part of the first path 70a is represented by the symbol A.

The correction circuit 50 includes, in addition to the same functional blocks as those in the first embodiment, a disturbance removal unit 71, a response compensation unit 72, an amplitude reduction filter unit 73, a conversion table 74, a disturbance removal filter unit 75, a sampling number increase unit 76, a switch 77 and a minus cut unit 78. In the present embodiment, the conversion table 54 is called as a first conversion table 54, and the conversion table 74 is called as a second conversion table 74.

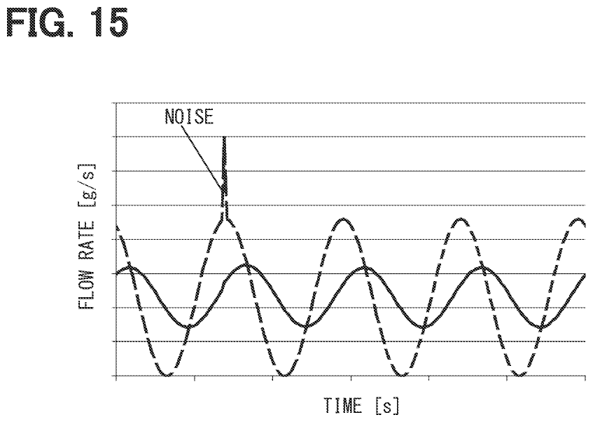

The disturbance removal unit 71 is a functional block that is provided between the variation adjusting unit 53 and the first conversion table 54 to receive the output value processed by the variation adjusting unit 53. The disturbance removal unit 71 is a sudden change limiting unit that limits a sudden large change in the output value when a rate of change with respect to the previous output value exceeds a predetermined reference value. For example, the disturbance removal unit 71 limits the amount of change within a predetermined value. When the noise shown in FIG. 15 is included in the output value, this noise is removed by the disturbance removal unit 71.

The response compensation unit 72 is a functional block that is provided between the disturbance removal unit 71 and the first conversion table 54 to receive the output value processed by the disturbance removal unit 71. The response compensation unit 72 is a filter that faithfully reproduces an abrupt change in the air flow rate actually detected by the sensing portion 22 to the output value. The response compensation unit 72 is formed of, for example, a high-pass filter. The output value compensated by the response compensation unit 72 is in a state where the response is advanced in time and the frequency range is wider than the output value before the compensation.

The amplitude reduction filter unit 73 is a functional block that is provided between the first conversion table 54 and the pulsation error correcting unit 61, and receives the output value processed by the first conversion table 54. The amplitude reduction filter unit 73 is a filter unit that smooths and reduces the pulsation amplitude Pa of the output value, and is formed of, for example, a low-pass filter. Since the process of the amplitude reduction filter unit 73 is performed after the process of the first conversion table 54, the average air volume Gave calculated using the output value does not change.

The first path 70a is connected between the first conversion table 54 and the pulsation error correcting unit 61, and the second path 70b is connected between the disturbance removal unit 71 and the response compensation unit 72. Both of the first path 70a and the second path 70b are connected to the pulsation amplitude calculator 58 via the switch 77. The switch 77 is a switching unit that selectively connects the first path 70a or the second path 70b to the pulsation amplitude calculator 58. When the switch 77 is in the first state, the pulsation amplitude calculator 58 is connected to the first path 70a, while being blocked from the second path 70b. When the switch 77 is in the second state, the pulsation amplitude calculator 58 is connected to the second path 70b while being blocked from the first path 70a.

The switch 77 is set to one of the first state and the second state when the airflow meter 10 is manufactured, and basically holds the state after being mounted on the vehicle. It should be noted that the switch 77 may be switched according to the engine operating state after being mounted on the vehicle.

The second conversion table 74 is a functional block that is provided between the disturbance removal unit 71 and the switch 77 on the second path 70b and receives the output value processed by the disturbance removal unit 71. Unlike the first conversion table 54, the second conversion table 74 converts the sampling value acquired by the sampling unit 52 into an air flow rate before the process of the response compensation unit 72 is performed.

The disturbance removal filter unit 75 is a functional block provided between the second conversion table 74 and the upper extreme determiner 56 on a path branched from the second path 70b, and the output value processed by the second conversion table 74 is input into the disturbance removal filter unit 75. The disturbance removal filter unit 75 is a filter unit that smooths and removes an output value included in a higher-order component that is a harmonic component, and is formed of, for example, a low-pass filter. The disturbance removal filter unit 75 is capable of variably setting the filter constant.

The sampling number increase unit 76 is a functional block that is provided between the disturbance removal filter unit 75 and the upper extreme determiner 56, and receives the output value processed by the disturbance removal filter unit 75. The sampling number increase unit 76 is an up-sampling unit that increases the sampling value acquired by the sampling unit 52, and has a higher time resolution than the sampling unit 52. The sampling number increase unit 76 is formed of a filter such as a variable filter or a CIC filter.

The frequency calculator 59 adds the calculated pulsation frequency F to the pulsation error calculator 60 and outputs the calculation result to the disturbance removal filter unit 75. The disturbance removal filter unit 75 feedback-controls the optimum filter constant using the pulsation frequency F from the frequency calculator 59.

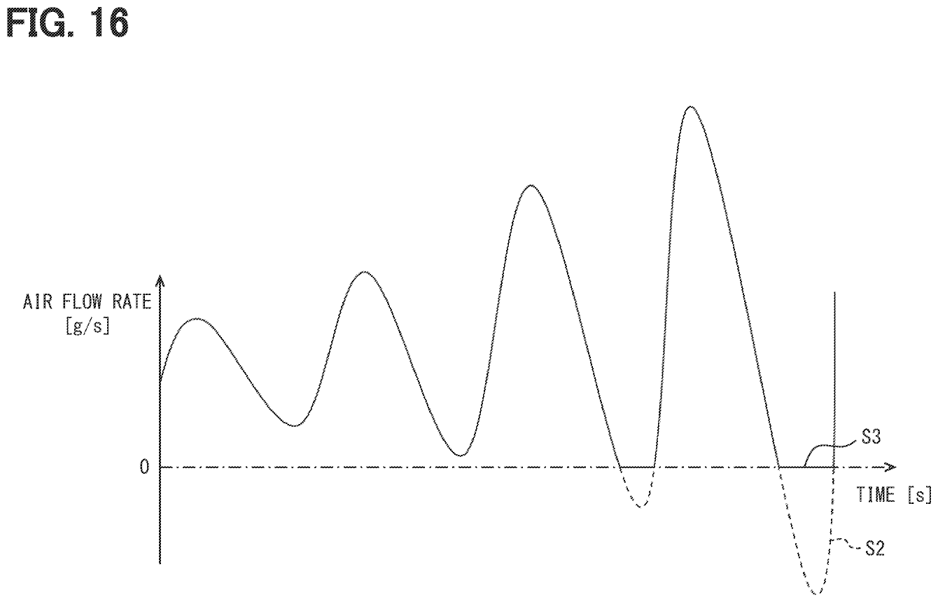

The minus cut unit 78 calculates an output value S3 by cutting the minus value of the corrected output value S2. As shown in FIG. 16, when the corrected output value S2 includes a negative value, which is a minus value, the minus cut unit 78 cuts the negative value to zero, so that the cut output value S3 does not include a negative value. Regarding the positive value that is a pulse value, the corrected output value S2 and the cut output value S3 are the same value. As described above, the measurement outlet 36 is installed at a position where it is difficult for the back flow to be generated in the intake passage 12 to flow from the measurement outlet 36 in the housing 21. However, the back flow from the measurement outlet 36 is not always zero. In this case, the flow rate of backward air entering from the measurement outlet 36 becomes unstable, and it becomes difficult to measure the air flow rate accurately. Therefore, the measurement accuracy of the air flow rate can be improved by performing the processing of the minus cut unit 78.

The correction circuit 50 outputs the output value S3 calculated by the minus cut unit 78 to the output circuit 62, in addition to the corrected average air volume Gave2 calculated by the pulsation error correcting unit 61 and the corrected output value S2. Then, the output circuit 62 outputs the corrected average air volume Gave2, the corrected output value S2, and the cut output value S3 to the ECU 46.

### Third Embodiment

In the first embodiment, the correction circuit 50 has the upper extreme determiner 56. In the third embodiment, the correction circuit 50 has the lower extreme determiner 81. In the present embodiment, differences from the first embodiment will be mainly described.

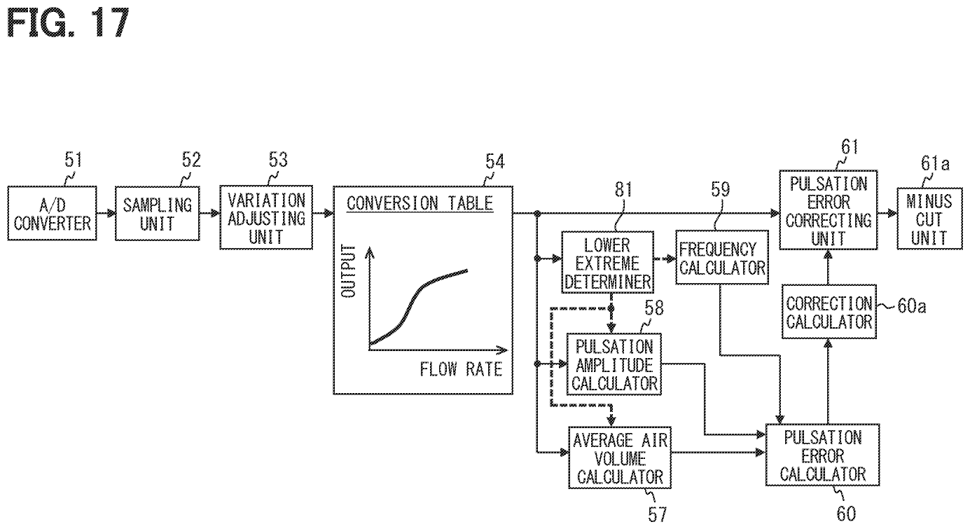

As shown in FIG. 17, the lower extreme determiner 81 is provided between the conversion table 54 and the frequency calculator 59 in the correction circuit 50. The lower extreme determiner 81 determines whether or not the sampled value subjected to the processing of the conversion table 54 is the lower extreme Eb. As described above, the lower extreme Eb is a sampling value at the timing when the output value switches from decreasing to increasing. The lower extreme determiner 81 acquires the timing at which the sampling value reaches the lower extreme Eb as the lower extreme timing tb, and stores the timing in the storage device of the processor 45. Then, the lower extreme determiner 81 outputs information including the lower extreme timing tb to the average air volume calculator 57, the pulsation amplitude calculator 58, and the frequency calculator 59 as timing information indicating the pulsation cycle. When the output value becomes the lower extreme Eb, it is determined that the specific condition is satisfied. The lower extreme determiner 81 corresponds to the pulsation state calculator and the condition determiner. The lower extreme timing tb corresponds to a timing when the output value satisfies the specific condition.

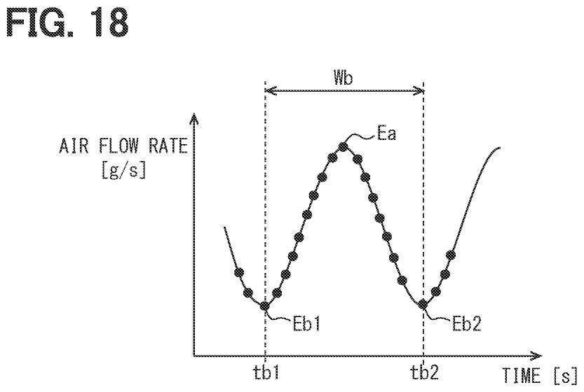

The frequency calculator 59 uses the timing information from the lower extreme determiner 81 to calculate the interval between which the sampling value becomes the lower extreme Eb as the lower extreme interval Wb. The frequency calculator 59 calculates the pulsation frequency Fb using the lower extreme interval Wb. For example, as shown in FIG. 18, the sampling value becomes the lower extreme Eb and then the sampling value becomes the lower extreme Eb. The previous lower extreme Eb is referred to as a first lower extreme Eb1. The next lower extreme Eb is referred to as a second lower extreme Eb2. In this case, the frequency calculator 59 calculates the lower extreme interval Wb between the first lower extreme timings tb1 at which the sampling value becomes the first lower extreme Eb1 and the second lower extreme timing tb2 at which the sampling value becomes the second lower extreme Eb2. Then, the pulsation frequency F is calculated, for example, using the relationship of F [Hz]=1/Wb [s]. The lower extreme interval Wb corresponds to a time interval.

The pulsation minimum value Gmin in the period from the first lower extreme timing tb1 to the second lower extreme timing tb2 is a smaller value of the first lower extreme Eb1 and the second lower extreme Eb2. When the first lower extreme Eb1 and the second lower extreme Eb2 are the same value, that value becomes the pulsation minimum value Gmin. The average value of the first lower extreme Eb1 and the second lower extreme Eb2 may be the pulsation minimum value Gmin.

According to this embodiment, the pulsation frequency F is calculated using the lower extreme interval Wb between the first lower extreme timing tb1 at which the output value becomes the first lower extreme Eb1 and the second lower extreme timing tb2 at which the output value becomes the second lower extreme Eb2. With this configuration, the lower extreme determiner 81 can calculate the lower extreme interval Wb by reading the two lower extreme timings tb1 and tb2 from the storage device while the lower extreme timing tb corresponding to the lower extreme Eb during the measurement period is stored in the storage device. Therefore, similarly to the first embodiment, it is possible to reduce the capacity and the size of the storage device.

Further, in this configuration, the pulsation frequency F can be obtained by calculating the reciprocal of the lower extreme interval Wb. Therefore, it is not necessary to use a function or a map when calculating the pulsation frequency F, compared with a case where the pulsation frequency F is calculated using, for example, the change rate or the change mode of the output value. Therefore, similarly to the first embodiment, it is possible to more surely reduce the capacity and the size of the storage device.

Further, in this configuration, the lower extreme interval Wb and the pulsation frequency F can be calculated using only the lower extreme Eb at which the output value changes from decreasing to increasing while the output value increases or decrease with the pulsation. Therefore, similarly to the first embodiment, the calculation accuracy of the pulsation frequency F can be improved regardless of the magnitude of the output value.

### Fourth Embodiment

In the first embodiment, the correction circuit 50 has the upper extreme determiner 56. In the fourth embodiment, the correction circuit 50 has the increase threshold determiner 82. In the present embodiment, differences from the first embodiment will be mainly described.

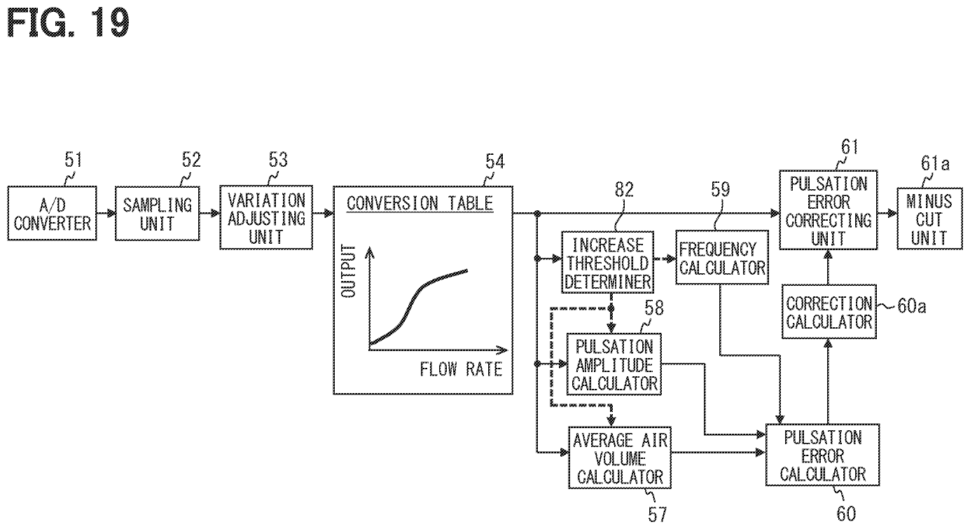

As shown in FIG. 19, the increase threshold determiner 82 is provided between the conversion table 54 and the frequency calculator 59 in the correction circuit 50. The increase threshold determiner 82 determines whether or not the output value processed by the conversion table 54 increases and exceeds a predetermined increase threshold Ec. When the output value becomes larger than the increase threshold Ec, the increase threshold determiner 82 acquires the timing at which the output value reaches the increase threshold Ec as the increasing timing tc and stores the timing in the storage device of the processor 45. Then, the increase threshold determiner 82 outputs the information including the increasing timing tc to the average air volume calculator 57, the pulsation amplitude calculator 58, and the frequency calculator 59 as timing information indicating the pulsation cycle. It is determined that the specific condition is satisfied when the output value being increased exceeds the increase threshold Ec. The increase threshold determiner 82 corresponds to a pulsation state calculator, a condition determiner and an increase determiner. The increasing timing tc corresponds to a timing when the output value meets the specific condition.

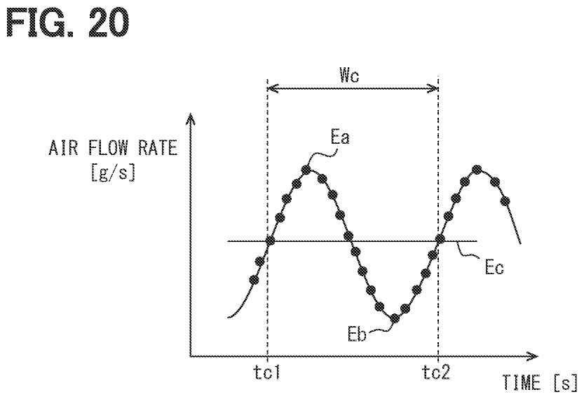

The frequency calculator 59 uses the timing information from the increase threshold determiner 82 to calculate an interval between which the output value during increasing exceeds the increase threshold Ec as the increase interval Wc, and calculates the pulsation frequency F using the increase interval Wc. For example, as shown in FIG. 20, the increasing output value exceeds the increase threshold Ec and then the increasing output value exceeds the increase threshold Ec next time. The timing at which the output value exceeds the increase threshold Ec firstly is called as a first increase timing tc1, and the timing at which the output value exceeds the increase threshold Ec the second time is called as a second increase timing tc2. In this case, the frequency calculator 59 uses the first increase timing tc1 and the second increase timing tc2 to calculate the increase interval We between the first increase timing tc1 and the second increase timing tc2. Then, the pulsation frequency F is calculated, for example, using the relationship of F [Hz]=1/Wc [s]. The increase interval We corresponds to a time interval.

According to this embodiment, the pulsation frequency F is calculated using the increase interval We between the increase timings tc1 and tc2 at which the increasing output value exceeds the increase threshold Ec. In this configuration, the increase threshold determiner 82 can read out the two increase timings tc1 and tc2 from the storage device and calculate the increase interval We if the increase timings tc1 and tc2 are stored in the storage device, during the measurement period. Therefore, similarly to the first embodiment, it is possible to reduce the capacity and the size of the storage device.

Further, in this configuration, since the pulsation frequency F can be obtained by calculating the reciprocal of the increase interval Wc, there is no need to use a function or map when calculating the pulsation frequency F, compared with a case where the pulsation frequency F is calculated, for example, using the change rate or the change mode of the output value. Therefore, similarly to the first embodiment, it is possible to more surely reduce the capacity and the size of the storage device.

The output value may repeat a small increase/decrease due to noise while the output value repeats a large increase/decrease as a whole due to an actual change in the air flow rate. In this case, it is considered that the rate of change becomes large in the large increase/decrease in the output value, as the output value approaches the center between the upper extreme Ea and the lower extreme Eb. On the other hand, the rate of change in the small increase/decrease does not significantly change regardless of whether the output value is close to the upper extreme Ea or the lower extreme Eb.

In contrast, according to the present embodiment, it is possible to set the increase threshold Ec as a value close to the center between the upper extreme Ea and the lower extreme Eb. As described above, the rate of change associated with a large increase or decrease in the output value is likely to be larger than the rate of change associated with a minute increase or decrease in the output value, at the value close to the center between the extremes Ea and Eb. Therefore, the output value can be restricted from repeatedly exceeding the increase threshold Ec due to the minute increase or decrease in the output value. Accordingly, it is possible to accurately acquire the increase timing tc at which the output value exceeds the increase threshold Ec in response to the actual change of the air flow rate, regardless of the increase/decrease of the output value. As a result, the calculation accuracy of the pulsation frequency F can be raised.

The change rate associated with a large increase or decrease in the output value is likely to be smaller than the change rate associated with a minute increase or decrease in the output value, at a value close to the upper extreme Ea or the lower extreme Eb. Therefore, if the increase threshold Ec is set to a value close to the upper extreme Ea or the lower extreme Eb, it is likely that the output value repeatedly exceeds the increase threshold Ec due to a slight increase or decrease in the output value. In this case, the calculation accuracy of the increase timing tc and the increase interval We may be reduced. As a result, the calculation accuracy of the pulsation frequency F may be reduced. Thus, there is room for improvement in setting the increase threshold Ec to an appropriate value.

### Fifth Embodiment

In the first embodiment, the correction circuit 50 has the upper extreme determiner 56. In the fifth embodiment, the correction circuit 50 has the decrease threshold determiner 83. In the present embodiment, differences from the first embodiment will be mainly described.

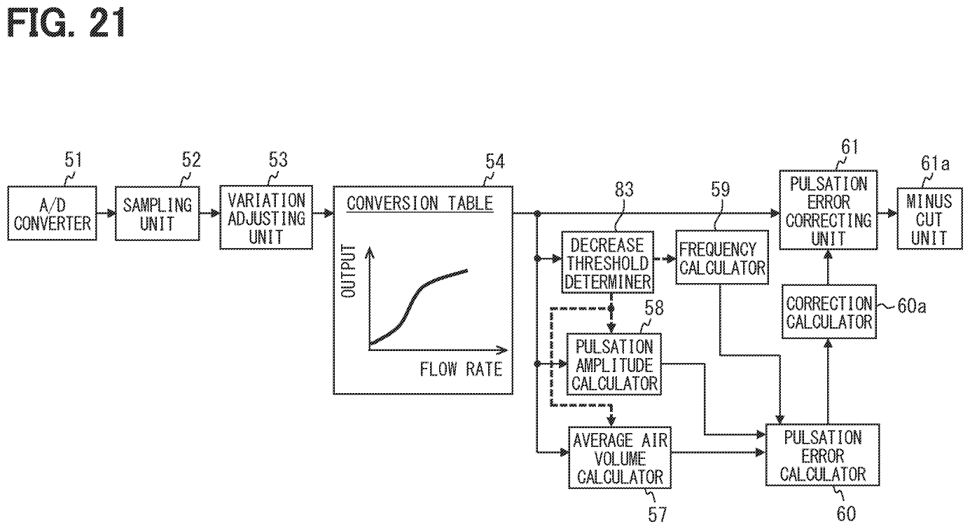

As shown in FIG. 21, the decrease threshold determiner 83 is provided between the conversion table 54 and the frequency calculator 59 in the correction circuit 50. The decrease threshold determiner 83 determines whether the output value processed by the conversion table 54 has exceeded a predetermined decrease threshold Ed to the decrease side. The decrease threshold determiner 83 acquires the timing at which the output value reaches the decrease threshold Ed as the decrease timing td when the output value being decreased becomes smaller than the decrease threshold Ed, and stores the timing in the storage device of the processor 45. Then, the decrease threshold determiner 83 outputs the information including the decrease timing td to the average air volume calculator 57, the pulsation amplitude calculator 58, and the frequency calculator 59 as timing information indicating the pulsation cycle. It is determined that the specific condition is satisfied when the output value being decreased exceeds the decrease threshold Ed to the decrease side. The decrease threshold determiner 83 corresponds to a pulsation state calculator, a condition determiner and a decrease determiner. The decrease timing td corresponds to a timing when the output value meets the specific condition.

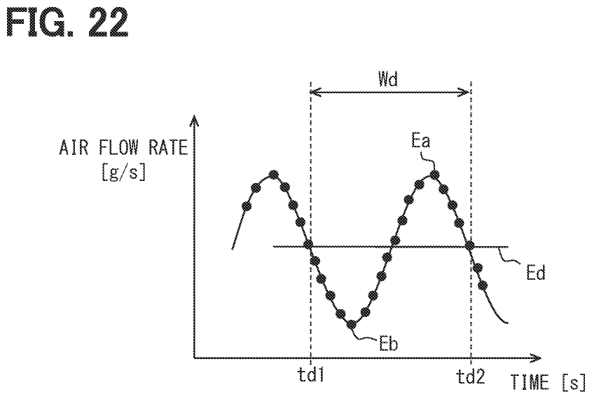

The frequency calculator 59 uses the timing information from the decrease threshold determiner 83 to calculate an interval between which the output value being decreased exceeds the decrease threshold Ed as a decrease interval Wd, and uses the decrease interval Wd to calculate the pulsation frequency F. For example, as shown in FIG. 22, the decreasing output value exceeds the decrease threshold Ed and then the decreasing output value exceeds the decrease threshold Ed next. The timing at which the output value exceeds the decrease threshold Ed firstly is called as the first decrease timing td1, and the timing at which the output value exceeds the decrease threshold Ed next is called as the second decrease timing td2. In this case, the frequency calculator 59 uses the first decrease timing td1 and the second decrease timing td2 to calculate the decrease interval Wd between the decrease timings td1 and td2. Then, the pulsation frequency F is calculated, for example, using the relationship of F [Hz]=1/Wd [s]. The decrease interval Wd corresponds to a time interval.

According to this embodiment, the pulsation frequency F is calculated using the decrease interval Wd between the decrease timings td1 and td2 when the decreasing output value exceeds the decrease threshold Ed. In this configuration, the decrease threshold determiner 83 can calculate the decrease interval Wd by reading the two decrease timings td1 and td2 from the storage device if the decrease timings td1 and td2 are stored in the storage device, during the measurement period. Therefore, similarly to the first embodiment, it is possible to reduce the capacity and the size of the storage device.

Further, in this configuration, since the pulsation frequency F can be acquired by calculating the reciprocal of the decrease interval Wd, there is no need to use a function or map when calculating the pulsation frequency F, compared with a case where the pulsation frequency F is calculated using the change rate or the change mode of the output value. Therefore, similarly to the first embodiment, it is possible to more surely reduce the capacity and the size of the storage device.

According to the present embodiment, it is possible to set the decrease threshold Ed around a value close to the middle between the upper extreme Ea and the lower extreme Eb. As described above, the rate of change associated with a large increase or decrease in the output value is likely to be larger than the rate of change associated with a minute increase or decrease in the output value at the value close to the center between the extremes Ea and Eb. The output value can be restricted from repeatedly exceeding the decrease threshold Ed with the minute increase or decrease. Therefore, regardless of the increase or decrease of the output value, it is possible to accurately acquire the decrease timing td at which the output value exceeds the decrease threshold Ed in response to the actual change in the air flow rate. As a result, the calculation accuracy of the pulsation frequency F can be increased.

The change rate associated with a large increase or decrease in the output value is likely to be smaller than the change rate associated with a minute increase or decrease in the output value, around a value close to the upper extreme Ea or the lower extreme Eb. Therefore, when the decrease threshold Ed is set to a value close to the upper extreme Ea or the lower extreme Eb, it is likely that the output value repeatedly exceeds the decrease threshold Ed in response to a slight increase or decrease in the output value. In this case, the calculation accuracy of the decrease timing td and the decrease interval Wd is reduced, and as a result, the calculation accuracy of the pulsation frequency F may be reduced. Therefore, there is room for improvement in setting the decrease threshold Ed to an appropriate value.

### Sixth Embodiment

In the first embodiment, the ECU 46 calculates the corrected average air volume Gave2. In the sixth embodiment, the pulsation error correcting unit 61 calculates a corrected average air volume Gave3. In the present embodiment, differences from the first embodiment will be mainly described.

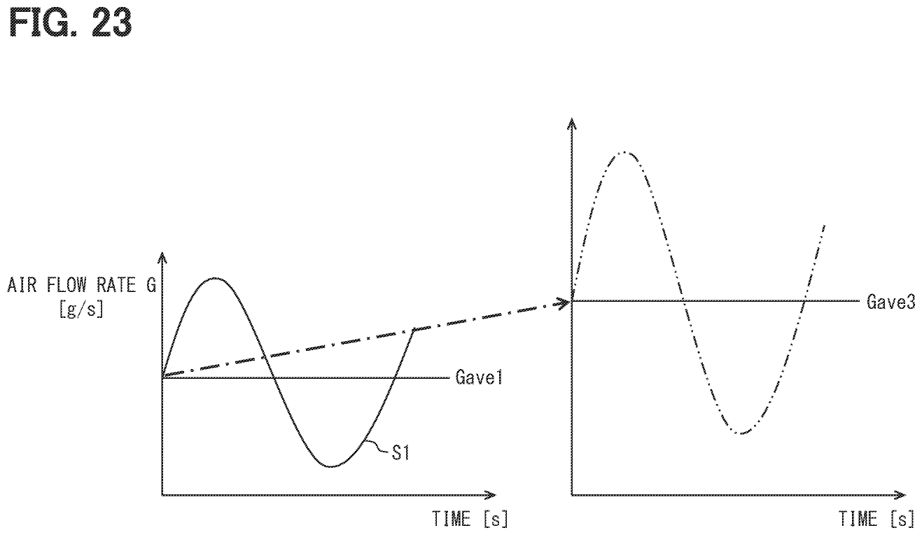

The pulsation error correcting unit 61 does not calculate the corrected output value S2 by using the uncorrected output value 51, but calculates an uncorrected average air volume Gave1 by using the uncorrected output value S1. The average air volume Gave1 is corrected by the correction amount Q to calculate the corrected average air volume Gave3. In the present embodiment, the uncorrected average air volume Gave1 is multiplied with the correction amount Q to calculate the average air volume Gave3 as a corrected value. In this case, the relationship of Gave3=Gave1×Q is satisfied. For example, when the correction amount Q is larger than 1, as shown in FIG. 23, the corrected average air volume Gave3 becomes larger than the uncorrected average air volume Gave1.

The correction amount Q calculated by the correction calculator 60a is different between the present embodiment and the first embodiment. That is, the correction amount Q is set according to whether or not the uncorrected average air volume Gave1 is used as a parameter the pulsation error correcting unit 61 uses to calculate the corrected average air volume Gave3. The correction amount Q may be set regardless of the parameter used to calculate the average air volume Gave3. Further, regarding the air flow rate, the corrected average air volume Gave3 corresponds to an average value and a measurement result.

According to the present embodiment, the pulsation error correcting unit 61 calculates the corrected average air volume Gave3 using the uncorrected average air volume Gave1. In this configuration, it is possible to use all of the output values S1 to calculate the uncorrected average air volume Gave1 during the measurement period. Therefore, the calculation accuracy of the uncorrected average air volume Gave1 and the corrected average air volume Gave3 can be improved. If all the uncorrected output values S1 larger than a predetermined reference value are deleted to calculate the corrected average air volume Gave1 using the remaining output values S1, differently from the present embodiment, the output values S1 larger than the reference value do not contribute to the uncorrected average air volume Gave1 and the corrected average air volume Gave3. Therefore, if the detection accuracy of the output value S1 larger than the reference value is relatively high, the calculation accuracy of the uncorrected average air volume Gave1 and the corrected average air volume Gave3 may be low.

The correction calculator 60a may calculate the corrected output value S2 using the uncorrected output value S1 and may calculate the average air volume Gave2 using the corrected output value S2, similarly to the ECU 46 of the first embodiment. Further, in the present embodiment, the ECU 46 may calculate the corrected average air volume Gave2 using the uncorrected average air volume Gave1. Furthermore, the correction calculator 60a need not calculate the corrected average air volume Gave1 using the uncorrected output value S1. For example, the correction calculator 60a may use the uncorrected output value S1 to calculate a specific air amount that is larger or smaller than the uncorrected average air volume Gave1. In this case, the correction calculator 60a calculates the corrected specific air amount using the uncorrected specific air amount.

### Seventh Embodiment

In the present embodiment, a noise removal function is added to the measurement control device according to the first embodiment.

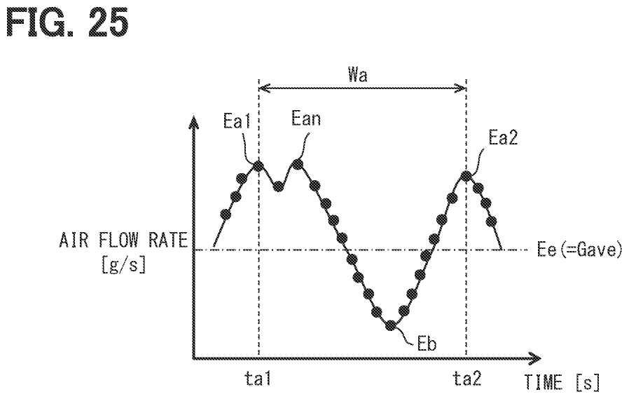

For example, as shown in FIG. 25, an upper extreme Ean may be caused by noise in the waveform representing the time change of the output value of the sensing portion 22 or the conversion value of the conversion table 54. This noise is not electrical noise, but is caused by air turbulence. Specifically, the flow rate (air flow rate) of the intake air flowing through the intake passage 12 becomes unstable when the combustion cycle is changed, for example, from the intake stroke to the compression stroke in a cylinder of the internal combustion engine. Due to such turbulence of air, in the waveform shown in FIG. 25, the upper extreme Ean is caused by noise immediately after the upper extreme Ea1. That is, a minor increase or decrease is repeated in the waveform.

The upper extreme determiner 56 makes a negative determination to cancel the upper extreme Ean caused by noise, and determines that the upper extreme Ean is not to be used for calculating the upper extreme interval Wa. Specifically, the upper extreme determiner 56 determines whether or not the output value is lower than or equal to a predetermined lower threshold Ee in a period from the upper extreme timing ta1 at which the upper extreme Ea1 appeared last time to the timing at which the upper extreme Ean appears this time. When it is determined that the output value is not lower than the lower threshold Ee, the current upper extremal Ean is considered to be caused by noise and is canceled.

The lower threshold Ee is set to the average air volume Gave calculated immediately before by the average air volume calculator 57. The lower threshold Ee may be set based on the pulsation frequency F calculated immediately before by the frequency calculator 59, in addition to the average air volume Gave. For example, a map showing the correspondence relationship between the average air volume Gave and the pulsation frequency F and the lower threshold Ee is stored in advance in the memory. The lower threshold Ee may be set by referring to the map, based on the average air volume Gave and the pulsation frequency F. Alternatively, the lower threshold Ee may be set based on the pulsation frequency F.

For example, the lower threshold Ee may be set to a smaller value as the pulsation frequency F is larger. The lower threshold Ee may be set to a smaller value as the average air volume Gave is larger. Alternatively, the lower threshold Ee may be set to a larger value as the pulsation frequency F is larger. The lower threshold Ee may be set to a larger value as the average air volume Gave is larger.

After canceling, the upper extreme determiner 56 detects the upper extreme Ea2 that appears next time, and sets the detection timing as the second upper extreme timing ta2. The detection timing of the upper extreme Ea1 that appeared last time corresponds to the first upper extreme timing ta1. It is determined that the predetermined specific condition is satisfied when the output value becomes the first upper extreme Ea1 or the second upper extreme Ea2. The predetermined specific condition is not satisfied when the output value becomes the upper extreme Ean due to noise.

The frequency calculator 59 calculates the interval between the upper extreme timings ta1 and ta2 as the upper extreme interval Wa in the same manner as in FIG. 7. That is, since the upper extreme Ean caused by noise is canceled as described above, the upper extreme Ean is not used for the calculation of the upper extreme interval Wa by the frequency calculator 59.

Similar to FIG. 7, the pulsation amplitude calculator 58 calculates the pulsation amplitude Pa using the sampling value converted by the conversion table 54 and the timing information from the upper extreme determiner 56. The timing information used for calculating the pulsation amplitude Pa does not include the appearance timing of the upper extreme Ean caused by noise.

Similar to FIG. 7, the average air volume calculator 57 calculates the average air volume Gave using the sampling value converted by the conversion table 54 and the timing information from the upper extreme determiner 56. The timing information used for calculating the average air volume Gave does not include the appearance timing of the upper extreme Ean caused by noise.

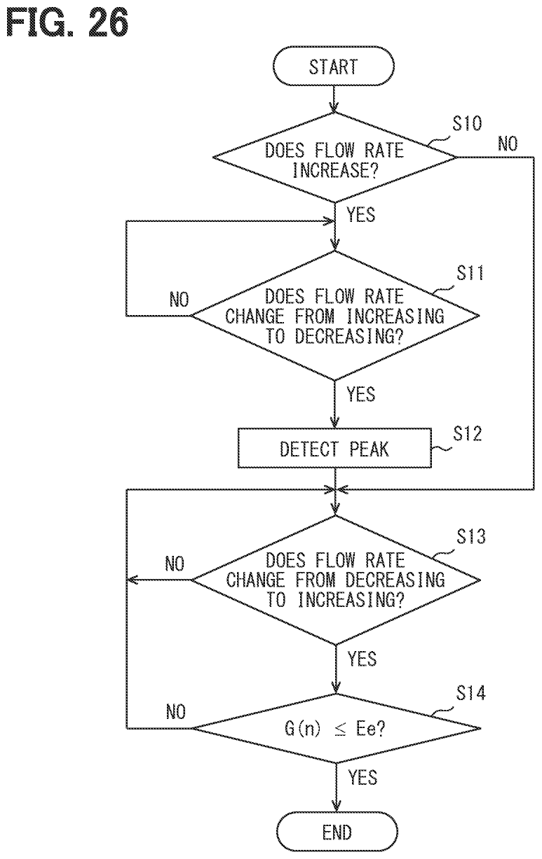

FIG. 26 is a flowchart showing the procedure of processing by the upper extreme determiner 56. The processing shown in FIG. 26 is repeatedly executed by the microcomputer while the output value is being input to the correction circuit 50. First, in S10, it is determined whether or not the flow rate is increasing at the present time in the waveform of the sampling value converted by the conversion table 54.

When it is determined that the flow rate is increasing, it is determined in S11 whether the flow rate has changed from increasing to decreasing. If it is determined that the flow rate has not changed to decreasing, the process of S11 is repeated. When it is determined that the flow rate has changed to decreasing, the processing of S12 is executed. That is, the process of S12 is waited until the flow rate is switched from the increasing to the decreasing.

In S12, the current sampling value is detected as the upper extreme Ea. After the processing of S12, or when it is determined in S10 that the flow rate is not increasing, the processing of S13 is executed. In S13, it is determined whether the flow rate has changed from decreasing to increasing. When it is determined that the flow rate has not changed to increasing, the process of S13 is repeated. If it is determined that the flow rate has changed to increasing, then in S14, it is determined whether or not the current sampling value has become equal to or lower than a predetermined lower threshold Ee.

If it is determined that the current sampling value is not lower than or equal to the lower threshold Ee, the process returns to S13. If it is determined that the current sampling value is equal to or lower than the lower threshold Ee, the process is restarted from S10. Therefore, S10 is restarted immediately after the flow rate is switched to the increasing. When it is determined that the flow rate is switched to increasing in S10, the process waits until the flow rate changes from increasing to decreasing (in S11), and the next upper extreme Ea is detected (in S12).

In short, after detecting the upper extreme Ea, it waits until the flow rate switches to increasing. After switching to increasing, it waits for the detection of the next upper extreme Ea. However, even in a case where switching to increasing, if the sampling value at that time is not lower than the lower threshold Ee, it does not shift to the state of waiting for detection of the next upper extreme Ea, but continues the waiting until the flow rate switches to increasing.

Therefore, according to the processing of FIG. 26, if the output value does not fall below the predetermined lower threshold Ee in the period from the previous upper extreme timing ta1 to the current upper extreme timing, the current upper extreme Ean will not be detected in S12. As a result, although the upper extremum Ean caused by noise appears in the actual waveform, it is canceled without being detected in S12.

According to the present embodiment, the upper extreme determiner 56 determines whether or not the upper extreme Ea1 is lower than or equal to the predetermined lower threshold Ee during the period from the upper extreme timing ta1 at which the upper extreme Ea1 appeared last time to the timing at which the upper extreme Ean at this time appears. When the output value does not fall below the lower threshold Ee, the upper extreme determiner 56 makes a negative determination to cancel the upper extreme Ean that appears this time. Therefore, the upper extreme Ean that appears due to the turbulence (noise) of the air caused by the switching in stroke of the combustion cycle can be restricted from being used for the correction by the correction circuit 50. Therefore, the correction accuracy of the air flow rate by the correction circuit 50 can be suppressed from being lowered due to the turbulence of the air.

The pulsation that appears in the waveform due to this type of air turbulence (noise) has a long wavelength, unlike electrical noise. Therefore, although the pulsation wavelength due to electrical noise is significantly different from the fluctuation wavelength when the air flow rate actually fluctuates, the pulsation wavelength due to air turbulence is close to the fluctuation wavelength. Therefore, it is extremely difficult to remove the pulsation caused by the air turbulence by the filter circuit, as compared with the case where the pulsation caused by the electric noise is removed by the filter circuit. According to the present embodiment, the upper extreme Ean due to the air turbulence can be canceled, so that the correction accuracy of the air flow rate can be improved.

Furthermore, in the present embodiment, when the lower threshold Ee is set based on at least one of the average air volume Gave and the pulsation frequency F, the upper extreme Ean caused by the air turbulence can be certainty canceled, even when the average air volume Gave and the pulsation frequency F dynamically change.

### Eighth Embodiment

In this embodiment, a noise removal function is added to the measurement control device according to the third embodiment.

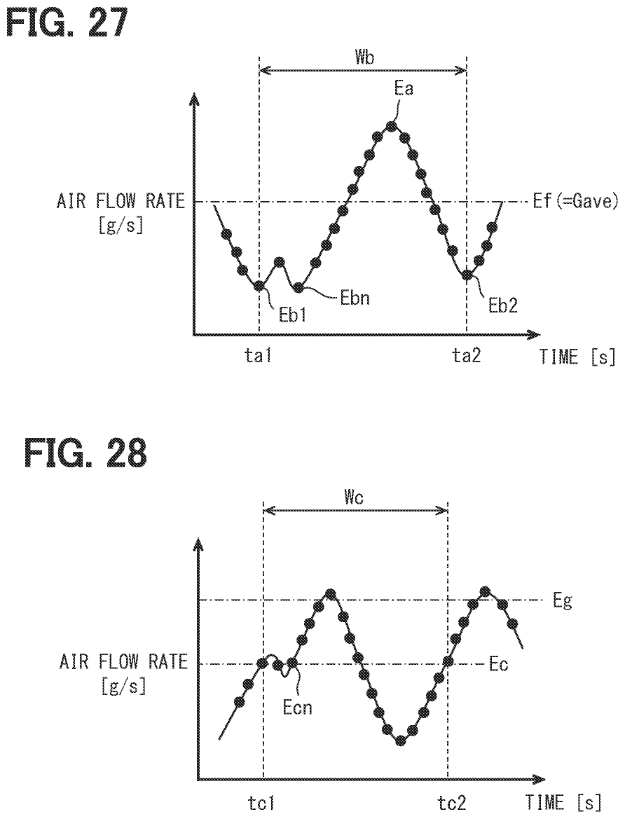

For example, as shown in FIG. 27, a lower extreme Ebn may be generated by noise in the waveform representing the time change of the output value of the sensing portion 22 or the conversion value of the conversion table 54. Similar to FIG. 25, this noise is also caused by a turbulence of the intake air caused by a switching in the stroke of the combustion cycle. Due to such turbulence of air, in the waveform shown in FIG. 27, the lower extreme Ebn is caused by noise immediately after the lower extreme Eb1. That is, the air flow rate repeats a slight increase and decrease in the waveform.

The lower extreme determiner 81 makes a negative determination to cancel the lower extreme Ebn caused by noise, so that the lower extreme Ebn is not used for calculating the lower extreme interval Wb. Specifically, the lower extreme determiner 81 determines whether or not the output value is higher than or equal to a predetermined upper threshold Ef during the period from the last lower extreme timing tb1 when the lower extreme Eb1 appeared last time to the timing when the lower extreme Ebn appears this time. If it is determined that the output value is not higher than or equal to the upper threshold Ef, the current lower extreme Ebn is considered to be caused by noise, and cancelled.

The upper threshold Ef is set to the average air volume Gave calculated immediately before by the average air volume calculator 57. The upper threshold Ef may be set based on at least one of the average air volume Gave and the pulsation frequency F as in the seventh embodiment.

After the canceling, the lower extreme determiner 81 detects the lower extreme Eb2 that appears next time, and sets the detection timing to the second lower extreme timing tb2. The detection timing when the lower extreme Eb1 appeared last time corresponds to the first lower extreme timing tb1. Further, it is determined that a predetermined specific condition is satisfied when the output value becomes the first lower extreme Eb1 or the second lower extreme Eb2. The specific condition is not satisfied when the output value becomes the lower extreme Ebn due to noise.

The frequency calculator 59 calculates the lower extreme interval Wb between the lower extreme timings tb1 and tb2 in the same manner as in FIG. 17. That is, since the lower extremum Ebn caused by noise is canceled as described above, the lower extremum Ebn caused by noise is not used in the calculation of the lower extreme interval Wb by the frequency calculator 59.

Similar to FIG. 17, the pulsation amplitude calculator 58 calculates the pulsation amplitude Pa using the sampling value converted by the conversion table 54 and the timing information from the lower extreme determiner 81. The timing information used for the calculation of the pulsation amplitude Pa does not include the timing when the noise-induced lower extreme Ebn appears.

The average air volume calculator 57 calculates the average air volume Gave using the sampling value converted by the conversion table 54 and the timing information from the lower extreme determiner 81, as similarly to FIG. 17. The timing information used for calculating the average air volume Gave does not include the timing when the noise-induced lower extreme Ebn appears.

According to the present embodiment, the lower extreme determiner 81 determines whether or not the lower extreme Eb1 is higher than or equal to the predetermined upper threshold Ef during the period from the lower extreme timing tb1 at which the lower extreme Eb1 appeared last time to the timing at which the lower extreme Ebn at this time appears. When the air flow rate is not higher than the upper threshold Ef, the lower extreme determiner 81 makes a negative determination to cancel the lower extreme Ebn that appears this time. Therefore, the lower extreme Ebn caused by the turbulence (noise) of the air due to the switching in stroke of the combustion cycle can be restricted from being used for the correction by the correction circuit 50. Therefore, the correction accuracy of the air flow rate by the correction circuit 50 can be suppressed from being lowered due to the turbulence of the air.

As described above, it is more difficult to remove the pulsation caused by the air turbulence with the filter circuit than to remove the pulsation caused by the electrical noise. According to the present embodiment, the lower extreme Ebn caused by the air turbulence can be canceled, so that the correction accuracy of the air flow rate can be improved.

Further, in the present embodiment, when the upper threshold Ef is set based on at least one of the average air volume Gave and the pulsation frequency F, the following effects are exhibited. That is, even when the average air volume Gave or the pulsation frequency F dynamically changes, it is possible to improve the certainty of canceling the lower extreme Ebn caused by the air turbulence.

### Ninth Embodiment

In this embodiment, a noise removing function is added to the measurement control device according to the fourth embodiment.

For example, as shown in FIG. 28, a noise pulsation may repeat a slight increase and decrease due to air turbulence in the waveform representing the time change of the output value of the sensing portion 22 or the conversion value of the conversion table 54. When such a noise pulsation appears near the increase threshold Ec, the increasing output value may exceed the increase threshold Ec at a timing different from the actual pulsation cycle of the air flow rate. In the example of FIG. 28, the air flow rate has a value of Ecn arriving at the increase threshold when the air flow rate exceeds threshold Ec due to noise pulsation. Similar to FIG. 25, this noise pulsation is also caused by the turbulence of the intake air caused by the switching in stroke of the combustion cycle.

The increase threshold determiner 82 makes a negative determination to cancel the timing when the air flow rate becomes the value Ecn arriving the increase threshold due to noise, and the timing when the air flow rate becomes the value Ecn arriving the increase threshold is not used for calculating the increase interval Wc. Specifically, the increase threshold determiner 82 determines whether or not the output value has reached a predetermined upper side threshold Eg during the period from the timing tc1 when the air flow rate becomes the value of the increase threshold last time to the timing when the air flow rate becomes the value of the increase threshold this time. When it is determined that the air flow rate has not reached the upper side threshold Eg, the current value Ecn of arriving at the increase threshold is considered to be due to noise, and is cancelled.

The upper side threshold Eg is set based on at least one of the average air volume Gave and the pulsation frequency F. The average air volume Gave used for this setting is calculated immediately before by the average air volume calculator 57. The pulsation frequency F used for this setting is calculated immediately before by the frequency calculator 59.

For example, the upper side threshold Eg may be set to a larger value as the pulsation frequency F is larger, and the upper side threshold Eg may be set to a larger value as the average air volume Gave is larger. Alternatively, the upper side threshold Eg may be set to a smaller value as the pulsation frequency F is larger, and the upper side threshold Eg may be set to a smaller value as the average air volume Gave is larger.

After the canceling, the increase threshold determiner 82 detects the value of the increase threshold that appears next time, and sets the detection timing as the second increase timing tc2. The detection timing of the value of the increase threshold that appeared last time corresponds to the first increase timing tc1. Further, when the output value has reached the value of the increase threshold, a predetermined specific condition is satisfied. When the output value reaches the arrival value Ecn of the increase threshold due to noise, the specific condition is not satisfied, since the timing is cancelled.

The frequency calculator 59 calculates the increase interval We between the increase timings tc1 and tc2, as in FIG. 19. That is, the arrival value Ecn of the increase threshold due to noise is canceled as described above, and thus is not used for the calculation of the increase interval We by the frequency calculator 59.

The pulsation amplitude calculator 58 calculates the pulsation amplitude Pa using the sampling value converted by the conversion table 54 and the timing information from the increase threshold determiner 82 in the same manner as in FIG. 19. The timing information used for calculating the pulsation amplitude Pa does not include the timing when the value Ecn arrives at the increase threshold due to noise.

The average air volume calculator 57 calculates the average air volume Gave using the sampling value converted by the conversion table 54 and the timing information from the increase threshold determiner 82, as in FIG. 19. The timing information used for calculating the average air volume Gave does not include the timing when the value Ecn arrives at the increase threshold due to noise.

According to the present embodiment, the increase threshold determiner 82 determines whether or not the output value reaches the upper side threshold Eg in the period from the timing at which the output value being increased exceeds the increase threshold Ec last time to the timing at which the output value being increased exceeds the increase threshold Ec this time. Then, when the output value does not reach the upper side threshold Eg, the increase threshold determiner 82 makes a negative determination to cancel the timing this time. Therefore, the timing of the value Ecn arriving at the increase threshold due to the turbulence (noise) of the air cause by switching in stroke of the combustion cycle cannot be used for the correction by the correction circuit 50. Therefore, the correction accuracy of the air flow rate by the correction circuit 50 can be suppressed from being lowered due to the turbulence of the air.

As described above, it is difficult to remove the pulsation due to the air turbulence by the filter circuit. According to the present embodiment, the timing of the value Ecn arriving at the increase threshold due to the air turbulence can be canceled, so that the correction accuracy of the air flow rate can be improved.

Further, in the present embodiment, when the upper side threshold Eg is set based on at least one of the average air volume Gave and the pulsation frequency F, the following effects are also exhibited. That is, even when the average air volume Gave and the pulsation frequency F dynamically change, it is possible to improve the certainty of canceling the timing when the value Ecn arrives at the increase threshold due to air turbulence.

### Tenth Embodiment

In this embodiment, a noise removal function is added to the measurement control device according to the fifth embodiment.

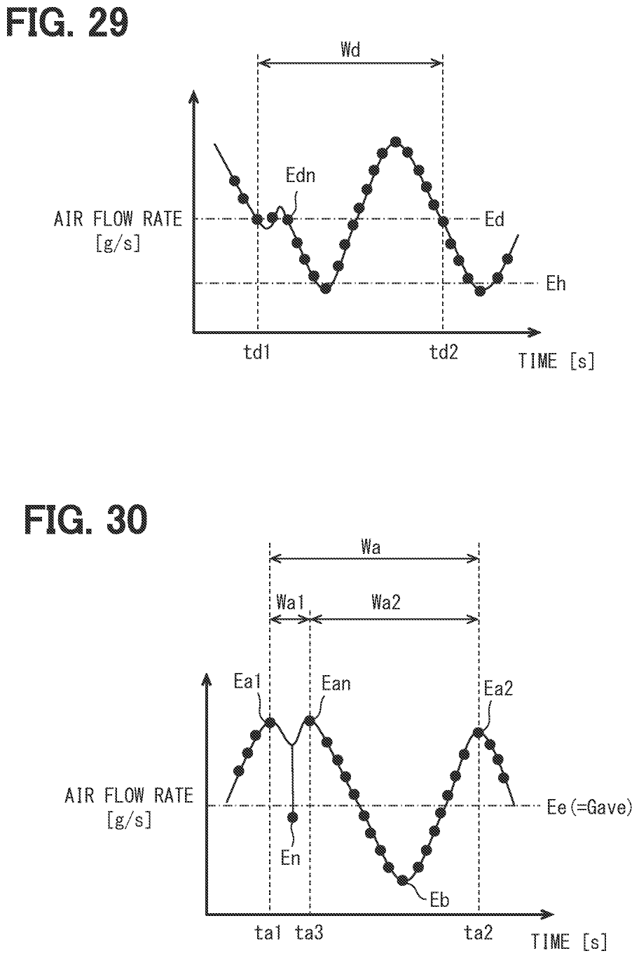

For example, as shown in FIG. 29, when a noise pulsation appears near the decrease threshold Ed, the decreasing output value may exceed the decrease threshold Ed at a timing different from the actual pulsation cycle of the air flow rate. In the example of FIG. 29, the air flow rate has a value of Edn arriving at the decrease threshold when the output value exceeds the decrease threshold Ed due to noise pulsation.

The decrease threshold determiner 83 makes a negative determination to cancel the timing of the value Edn arriving at the decrease threshold due to noise, and the timing of the value Edn is not used for calculating the decrease interval Wd. Specifically, the decrease threshold determiner 83 determines whether or not the output value has reached a predetermined lower side threshold Eh during the period from the timing td1 when the output value arrives at the decrease threshold last time to the timing when the output value currently arrives at the decrease threshold. If it is determined that the output value has not reached the lower side threshold Eh, the current value Edn arriving at the decrease threshold is considered to be due to noise, and is cancelled.

The lower side threshold Eh is set based on at least one of the average air volume Gave and the pulsation frequency F, as in the ninth embodiment.

After the canceling, the decrease threshold determiner 83 detects the value arriving at the decrease threshold next time, and sets the detection timing as the second decrease timing td2. The detection timing of the value arriving at the decrease threshold last time corresponds to the first decrease timing td1. Further, when the output value has reached the decrease threshold, it is determined that a predetermined specific condition is satisfied. When the output value has reached the value Edn due to noise, the specific condition is not satisfied by the cancelling.

The frequency calculator 59 calculates the decrease interval Wd between the decrease timings td1 and td2 in the same manner as in FIG. 21. In other words, the value Edn due to noise is canceled as described above, and therefore is not used for the calculation of the decrease interval Wd by the frequency calculator 59.

As in FIG. 21, the pulsation amplitude calculator 58 calculates the pulsation amplitude Pa using the sampling value converted by the conversion table 54 and the timing information from the decrease threshold determiner 83. The timing information used for the calculation of the pulsation amplitude Pa does not include the appearance timing of the noise-induced value Edn arriving at the decrease threshold.

The average air volume calculator 57 calculates the average air volume Gave by using the sampling value converted by the conversion table 54 and the timing information from the decrease threshold determiner 83, similarly to FIG. 21. The timing information used for calculating the average air volume Gave does not include the appearance timing of the noise-induced value Edn arriving at the decrease threshold.

According to the present embodiment, the decrease threshold determiner 83 determines whether or not the output value has reached the lower side threshold Eh during the period from the timing when the decreasing output value exceeds the decrease threshold Ed last time to the timing when it exceeds this time. If the output value does not reach the lower side threshold Eh, the decrease threshold determiner 83 makes a negative determination to cancel the timing this time. Therefore, the timing of the value Edn arriving at the decrease threshold due to the turbulence (noise) of the air caused by switching in stroke of the combustion cycle cannot be used for the correction by the correction circuit 50. Therefore, the correction accuracy of the air flow rate by the correction circuit 50 can be suppressed from being lowered due to the turbulence of the air.

As described above, it is difficult to remove the pulsation due to the air turbulence by the filter circuit. According to the present embodiment, as described above, it is possible to cancel the timing of the value Edn arriving at the decrease threshold due to air turbulence, so that it is possible to improve the correction accuracy of the air flow rate.

Further, in the present embodiment, when the lower side threshold Eh is set based on at least one of the average air volume Gave and the pulsation frequency F, the following effects are also exhibited. That is, even when the average air volume Gave or the pulsation frequency F dynamically changes, it is possible to improve the certainty of canceling the timing of the value Edn arriving at the decrease threshold due to air turbulence.

### Eleventh Embodiment

In this embodiment, a noise removal function is added to the measurement control device according to the seventh embodiment.

For example, an electric noise value En appears, in the waveform of the air flow rate shown in FIG. 30, which greatly changes instantaneously due to electric noise. The electric noise value En is generated between the upper extreme Ean caused by air turbulence and the first upper extreme Ea1. Therefore, in step S14 of FIG. 26, it is determined that the air flow rate becomes lower than or equal to the decrease threshold Ee, and the next upper extreme Ean is detected in step S12. That is, when the electric noise value En appears, there is a concern that the upper extreme Ean due to air turbulence cannot be canceled.

In this case, the interval between the first upper extreme Ea1 and the upper extreme Ean is calculated as the upper extreme interval Wa1. The interval between the upper extreme Ean and the second upper extreme Ea2 is calculated as the upper extreme interval Wa2. As a result, if the air flow rate is corrected by the upper extreme intervals Wa1 and Wa2 using the upper extreme Ean caused by the air turbulence, there is a concern that the correction accuracy of the air flow rate by the correction circuit 50 may decrease.

In response to this concern, in the present embodiment, when the pulsation frequency F calculated by the frequency calculator 59 is higher than a predetermined frequency threshold, correction by the pulsation error correcting unit 61 (flow rate correcting unit) is prohibited. In other words, when the upper extreme interval Wa1 used for calculating the pulsation frequency F is shorter than the predetermined interval threshold, the correction by the pulsation error correcting unit 61 is prohibited. The above-mentioned frequency threshold may be a fixed value or a value that is variably set based on at least one of the average air volume Gave and the pulsation frequency F.

When prohibiting the correction in this way, the correction amount calculated by the correction calculator 60a may be forcibly set to zero, instead of prohibiting the correction by the pulsation error correcting unit 61. Alternatively, the pulsation error calculated by the pulsation error calculator 60 may be forcibly set to zero.

As described above, according to the present embodiment, when the pulsation frequency F calculated by the frequency calculator 59 is higher than the predetermined frequency threshold, the correction by the pulsation error correcting unit 61 is prohibited. Therefore, the above-mentioned concern can be reduced such that the upper extreme Ean due to air turbulence can be canceled.

In the present embodiment, such correction inhibition is applied to the control for calculating the pulsation frequency F from the timing of the upper extreme Ea. The correction inhibition may be applied to the control for calculating the pulsation frequency F from the timing of the lower extreme Eb. Alternatively, the correction inhibition may be applied to the control for calculating the pulsation frequency F from the timing when the increase threshold Ec is exceeded. Alternatively, the correction inhibition may be applied to the control for calculating the pulsation frequency F from the timing when the decrease threshold Ed is exceeded.

### Twelfth Embodiment

In the present embodiment, a noise removal function is added to the measurement control device according to the first embodiment.

The pulsation amplitude calculator 58 described with reference to FIG. 7 calculates the pulsation amplitude Pa using the sampling value converted by the conversion table 54 and the timing information from the upper extreme determiner 56. For example, the pulsation amplitude Pa of the air flow rate is calculated by taking the difference between the pulsation maximum value Gmax and the average air volume Gave. When the pulsation amplitude calculator 58 uses the upper extremum Ean caused by the above-described noise with reference to FIG. 25 to calculate the pulsation amplitude Pa, the pulsation amplitude Pa has an extremely small value. As a result, the accuracy of correcting the air flow rate by the correction circuit 50 decreases.

Even when the air flow rate is stable and there is almost no pulsation, a slight pulsation amplitude Pa may occur due to air turbulence. In this case, if the pulsation amplitude Pa caused by the air turbulence is reflected in the correction of the air flow rate, the correction accuracy of the air flow rate by the correction circuit 50 is reduced.

With respect to these issues, in the present embodiment, when the pulsation amplitude Pa calculated by the pulsation amplitude calculator 58 is smaller than a predetermined pulsation amplitude threshold, the correction by the pulsation error correcting unit 61 (flow rate correcting unit) is prohibited. The pulsation amplitude threshold may be a fixed value or a value variably set based on at least one of the average air volume Gave and the pulsation frequency F.

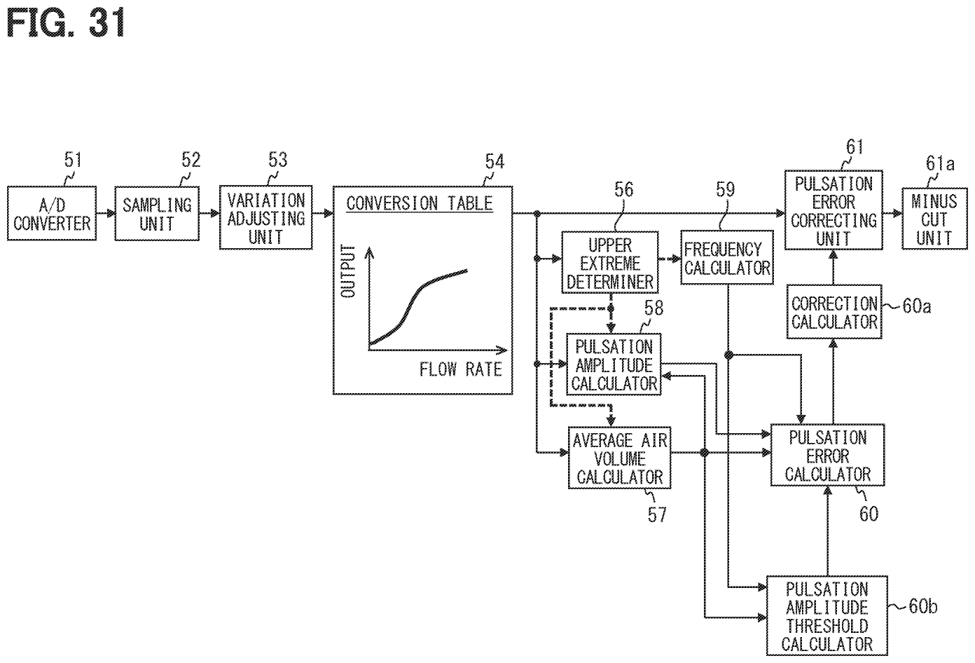

Specifically, in the present embodiment, as shown in FIG. 31, a pulsation amplitude threshold calculator 60b is added to the functional block shown in FIG. 7. A minus cut unit 61a having the same function as the minus cut unit 78 shown in FIG. 14 is also added in this embodiment.

The pulsation amplitude threshold calculator 60b acquires the pulsation frequency F calculated by the frequency calculator 59 and the average air volume Gave calculated by the average air volume calculator 57. The pulsation amplitude threshold calculator 60b calculates the above-mentioned pulsation amplitude threshold based on the acquired pulsation frequency F and the average air volume Gave.

For example, the pulsation amplitude threshold may be set to a smaller value as the pulsation frequency F increases, and the pulsation amplitude threshold may be set to a smaller value as the average air volume Gave increases. Alternatively, the pulsation amplitude threshold may be set to a larger value as the pulsation frequency F is larger, and the pulsation amplitude threshold may be set to a larger value as the average air volume Gave is larger.

The pulsation error calculator 60 acquires the pulsation amplitude threshold from the pulsation amplitude threshold calculator 60b, and acquires the pulsation amplitude Pa from the pulsation amplitude calculator 58. Then, when the acquired pulsation amplitude Pa is smaller than the pulsation amplitude threshold, the pulsation error Err calculated by the pulsation error calculator 60 is forcibly set to zero. As a result, the correction by the pulsation error correcting unit 61 (flow rate correcting unit) is prohibited.

As described above, according to the present embodiment, when the pulsation amplitude Pa is smaller than the pulsation amplitude threshold, the correction by the pulsation error correcting unit 61 (flow rate correcting unit) is prohibited. Therefore, even when the upper extreme Ean caused by noise is used to calculate the pulsation amplitude Pa, it is possible to restrict the correction accuracy of the air flow rate by the correction circuit 50 from being lowered.

In the present embodiment, the pulsation amplitude threshold is set based on at least one of the average air volume Gave and the pulsation frequency F. Therefore, even when the average air volume Gave or the pulsation frequency F dynamically changes, it is possible to certainty prohibit the correction due to the air turbulence.

### Thirteenth Embodiment

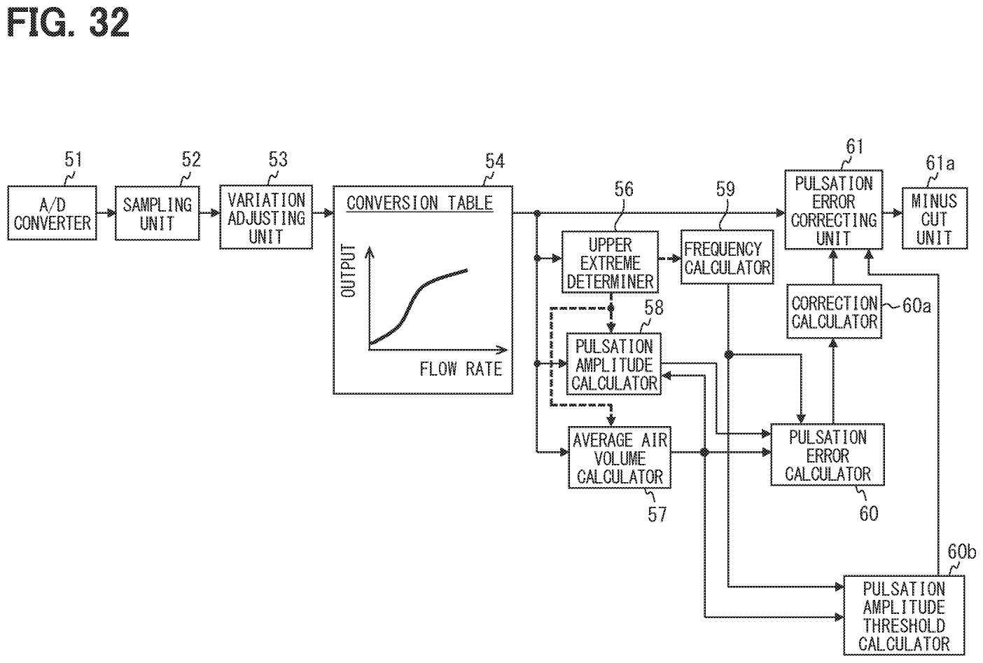

In the twelfth embodiment, the pulsation error calculator 60 acquires the pulsation amplitude threshold calculated by the pulsation amplitude threshold calculator 60b. Then, the pulsation error calculator 60 forcibly sets the pulsation error Err to zero, thereby prohibiting the correction by the pulsation error correcting unit 61. In the present embodiment, as shown in FIG. 32, the pulsation error correcting unit 61 acquires the pulsation amplitude threshold. Then, the pulsation error correcting unit 61 determines whether the pulsation amplitude Pa is smaller than the pulsation amplitude threshold. When it is determined that the pulsation amplitude Pa is smaller than the pulsation amplitude threshold, the pulsation error correcting unit 61 prohibits the correction of the air flow rate. According to this embodiment, the same effect as that of the fourteenth embodiment can be obtained.

As a modification of the present embodiment, the correction calculator 60a may acquire the pulsation amplitude threshold and determine whether the pulsation amplitude Pa is smaller than the pulsation amplitude threshold. When it is determined that the pulsation amplitude Pa is smaller than the pulsation amplitude threshold, the correction calculator 60a may force the correction amount Q to be zero, such that the correction by the pulsation error correcting unit 61 is prohibited.

The correction prohibition function according to this embodiment and the twelfth embodiment is applied to the control for calculating the pulsation frequency F from the timing of the upper extreme Ea. The correction prohibition function may be applied to the control for calculating the pulsation frequency F from the timing of the lower extreme Eb. Alternatively, the correction prohibition function may be applied to the control for calculating the pulsation frequency F from the timing when the increase threshold Ec is exceeded. Alternatively, the correction prohibition function may be applied to the control for calculating the pulsation frequency F from the timing when the decrease threshold Ed is exceeded.

### Fourteenth Embodiment

In the present embodiment, the following functions are added to the frequency calculator 59. The frequency calculator 59 excludes the frequencies equal to or higher than the upper limit and the frequencies lower than the lower limit to calculate the pulsation frequency. That is, the frequency calculator 59 calculates frequencies within the allowable range that is less than the upper limit and equal to or more than the lower limit as the pulsation frequency.

Further, the frequency calculator 59 excludes frequencies whose change rate is equal to or higher than an upper limit value and frequencies whose change rate is lower than a lower limit value, to calculate the pulsation frequency. That is, the frequency calculator 59 calculates the frequencies when the rate of change is within the allowable range less than the upper limit value and more than or equal to the lower limit value as the pulsation frequency. The “rate of change” is the amount of change in frequency that has changed per unit time. That is, in the waveform representing the time change of the output value of the sensing portion 22 or the conversion value of the conversion table 54, the “rate of change” corresponds to a slope of the waveform.

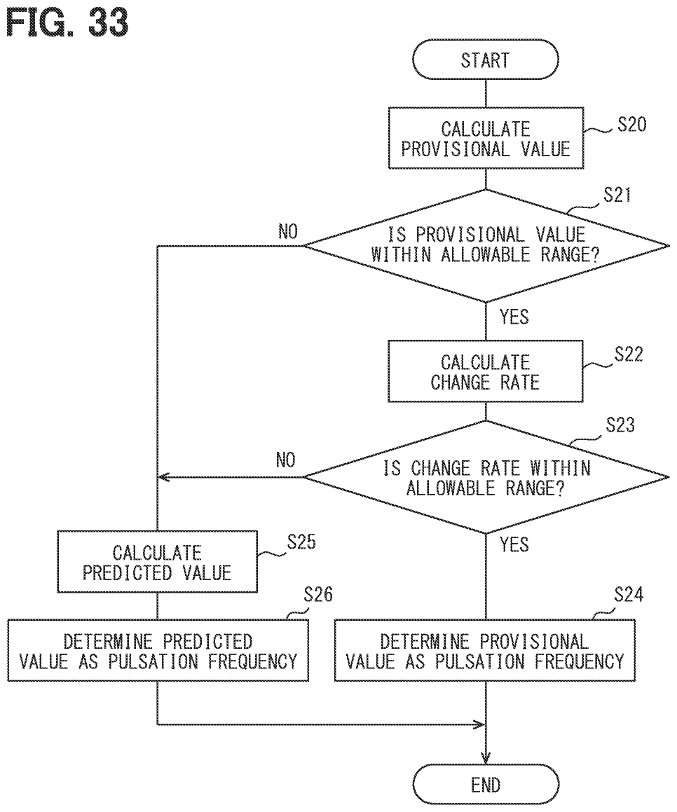

FIG. 33 shows a procedure of processing repeatedly executed by the microcomputer so as to exert the above-mentioned function during the period when the output value is input to the correction circuit 50.

First, in step S20, the value of the pulsation frequency calculated by the frequency calculator 59 by the method described in each of the embodiments is set as a provisional value. In the following step S21, it is determined whether or not the provisional value set in step S20 is within the allowable range.

When it is determined that the provisional value is within the allowable range, in the subsequent step S22, the rate of change of the provisional value set in step S20 is calculated. Specifically, the rate of change is calculated from the difference between the frequency acquired last time and the frequency acquired this time. In step S23, it is determined whether or not the rate of change calculated in the step S22 is within the allowable range.

When it is determined that the rate of change is also within the allowable range, in the subsequent step S24, the provisional value set in step S20 is set as the determined value of the pulsation frequency. In other words, the provisional value outside the allowable range and the provisional value having the rate of change outside the allowable range are excluded from the determined value of the pulsation frequency.

When it is determined that the provisional value is outside the allowable range, or when the rate of change is outside the allowable range, a predicted value of the pulsation frequency is calculated in step S25. For example, the predicted value of the pulsation frequency this time is calculated using the past determined value of the pulsation frequency. Alternatively, the previous determination value of the pulsation frequency is calculated as the predicted value of the present pulsation frequency. In the following step S26, the predicted value calculated in step S25 is set as the determined value of the pulsation frequency.

As described above, in the present embodiment, the frequency calculator 59 excludes frequencies outside the allowable range and determines the pulsation frequency. Therefore, a frequency outside the allowable range due to the influence of noise can be avoided from being determined as the pulsation frequency.

Further, in the present embodiment, the frequency calculator 59 determines the pulsation frequency by excluding the frequency whose rate of change rate is outside the allowable range. Therefore, a frequency that is greatly or slightly changed beyond the allowable range due to the influence of noise can be avoided from being determined as the pulsation frequency.

### Fifteenth Embodiment

In the present embodiment, the following functions are added to the disturbance removal filter unit 75. That is, the frequency of the waveform representing the time change of the engine speed is set as a rotation fluctuation frequency. The engine speed is the number of times the output shaft of the engine rotates per a predetermined time, and corresponds to the engine rotation speed. Then, the disturbance removal filter unit 75 is set to remove a component of a predetermined cutoff frequency from the waveform of the sampling value. The cutoff frequency is set to a positive real number multiple of the rotation fluctuation frequency. This real number may or may not be an integer.

Further, the disturbance removal filter unit 75 has a function of variably setting the cutoff frequency. The cutoff frequency is made larger as the engine speed increases. However, such a variable setting function is not essential. When the cutoff frequency is fixedly set, the cutoff frequency is set to a positive real multiple of the rotation fluctuation frequency in a specific operating state.

A low-pass filter is used in the disturbance removal filter unit 75. The waveform of the sampling value is smoothed and output, as described above in the second embodiment. Then, the higher the cutoff frequency, the smaller the time constant representing the degree of smoothing. Therefore, variably setting the cutoff frequency means variably setting the time constant. Therefore, it can be said that the disturbance removal filter unit 75 variably sets the time constant to a smaller value as the engine speed increases.

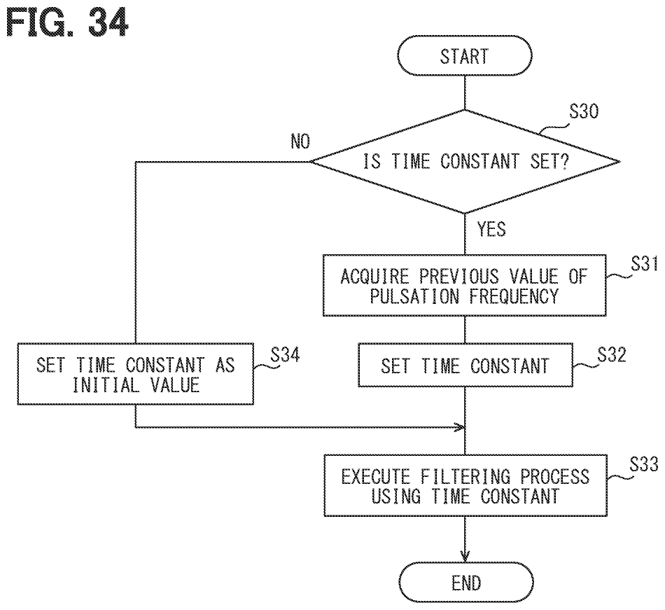

FIG. 34 shows a procedure of processing that is repeatedly executed by the microcomputer so that the above function is exerted while the output value is being input to the correction circuit 50.

First, in step S30, it is determined whether or not the time constant is set for step S32. For example, it is determined that the time constant is not set at the initial stage when the ECU 46 is activated and the correction circuit 50 is activated. In that case, in step S34, the time constant is set to an initial value stored in advance.

When it is determined that the time constant is set, in the subsequent step S31, the previous value of the pulsation frequency calculated by the frequency calculator 59 is acquired. In the following step S32, the time constant is variably set based on the pulsation frequency acquired in step S31. Specifically, the higher the pulsation frequency is, the smaller the time constant is set. It should be noted that the higher the pulsation frequency is, the higher the engine speed (rotation fluctuation frequency) is. Therefore, it can be said that the higher the rotation fluctuation frequency is, the smaller the time constant is set.

In the following step S33, the disturbance removal filter unit 75 executes the filtering process using the time constant set in step S32 or step S34. The disturbance removal filter unit 75 removes frequency noise (harmonic noise) caused by the pulsating frequency of the engine speed from the sampling waveform.

The disturbance removal unit 71 shown in FIG. 14 and the like removes the instantaneous noise illustrated in FIG. 15. The cutoff frequency of the disturbance removal unit 71 is set to a higher frequency than the cutoff frequency of the disturbance removal filter unit 75. The time constant of the disturbance removal unit 71 is set to a value smaller than the time constant of the disturbance removal filter unit 75.

A high-pass filter is used in the response compensation unit 72 shown in FIG. 14 and the like, to faithfully reproduce an abrupt change in the air flow rate to the output value, as described in the second embodiment. As a result, the waveform smoothed by the detection response delay by the sensing portion 22 is corrected to a waveform having the actual abrupt change. Then, when such a high-pass filter process is executed, the amplitude becomes large as illustrated in FIG. 13. Therefore, the amplitude reduction filter unit 73 shown in FIG. 14 and the like executes filter processing for reducing the amplitude.

However, in the waveform in which the amplitude is reduced in this way, the average air volume Gave deviates to the plus side from the actual average value. Therefore, the average air volume calculator 57 shown in FIG. 14 and the like calculates the average air volume Gave by using the values converted by the second conversion table 74 instead of the first conversion table 54. That is, the average air volume calculator 57 calculates the average air volume Gave using the values that have not been subjected to the filter processing of the response compensation unit 72 and the amplitude reduction filter unit 73. This improves the calculation accuracy of the average air volume Gave.

As described above, in the present embodiment, the cutoff frequency used in the disturbance removal filter unit 75 is set to a positive real number multiple of the rotation fluctuation frequency related to the engine rotation. Therefore, frequency noise (harmonic noise) caused by the pulsating frequency of the engine speed can be removed from the sampling waveform. Therefore, the measurement accuracy of the air flow rate can be improved.

In the present embodiment, the cutoff frequency used in the disturbance removal filter unit 75 is variably set to a larger value as the engine speed increases. Therefore, the cutoff frequency can be variably set according to the frequency of the harmonic noise that is generated as the engine speed changes. Therefore, the measurement accuracy of the air flow rate can be further improved.

Further, the resolution of the sampling waveform can be improved by increasing the sampling number by the sampling number increase unit 76. Therefore, it is possible to improve the detection accuracy of the extreme used to calculate the pulsation frequency, to improve the measurement accuracy of the air flow rate.

When the pulsation state calculator calculates the pulsation state by using the output value instead of acquiring it from an external device, there is a concern that the following noise is likely to be generated. For example, a rapid change is generated in the detected value by water adhering to the sensing portion 22. Such noise can be removed by the disturbance removal filter unit 75.

### Other Embodiments

Although the embodiments according to the present disclosure have been described above, the present disclosure is not construed as being limited to the embodiments, and can be applied to various embodiments and combinations within a scope not departing from the spirit of the present disclosure.

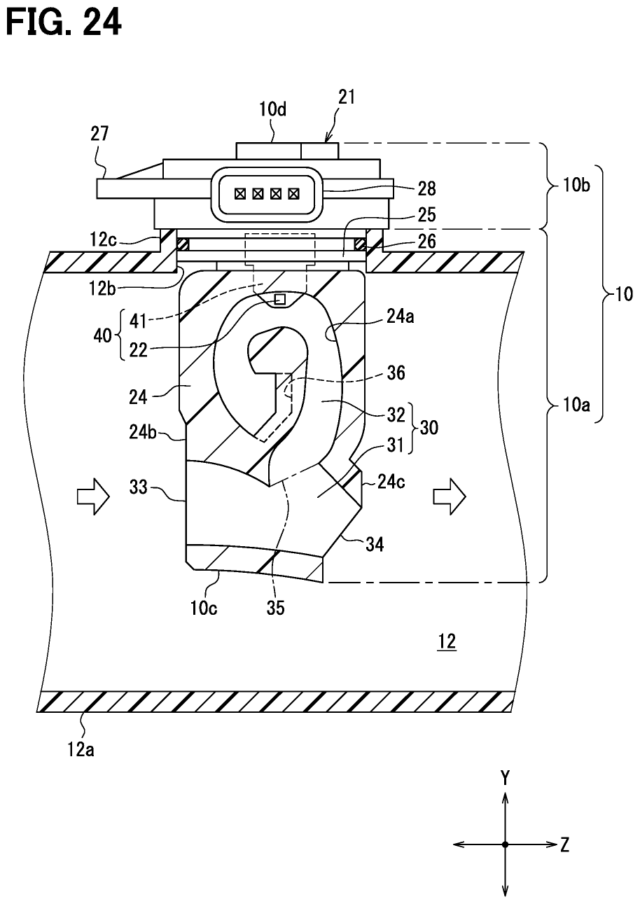

As Modification 1, the measurement outlet 36 may face the opposite side of the inflow port 33, similarly to the outflow port 34. For example, as shown in FIG. 24, the measurement outlet 36 is provided between the inflow port 33 and the outflow port 34 in the depth direction Z. In the above configuration, since the measurement outlet 36 is provided in a projection portion protruding from the outer peripheral surface of the housing 21 in the width direction X, the measurement outlet 36 is opened toward the downstream side of the intake passage 12 similarly to the outflow port 34. In the intake passage 12, the air flowing in the forward direction along the outer peripheral surface of the housing 21 passes through the measurement outlet 36, so that a turbulence such as a vortex flow is apt to occur around the measurement outlet 36 in the air flow. For that reason, even if the measurement outlet 36 faces the side opposite to the inflow port 33, it is considered that the backward flow does not easily flow into the measurement outlet 36 when the backward flow of the air occurs in the intake passage 12.

Also in the present modification, the pulsation error Err is calculated by use of the pulsation amplitude Pa. For that reason, the correction accuracy can be raised similarly to the first embodiment while the correction accuracy of the air flow is likely to be lowered as the backward flow is less likely to flow into the measurement outlet 36. Further, in the first embodiment, the measurement outlet 36 may be provided on the downstream outer surface 24c, so as to be opened toward the side opposite to the inflow port 33.

As Modification 2, in the housing 21, the entire measurement outlet 36 may be provided on the upstream outer surface 24b or the intermediate outer surfaces 24d, while a part of the measurement outlet 36 is provided on the upstream outer surface 24b and the remaining part is provided on the intermediate outer surfaces 24d in the embodiment. When the entire measurement outlet 36 is provided on the upstream outer surface 24b, the measurement outlet 36 is opened toward the side opposite to the outflow port 34. When the entire measurement outlet 36 is provided on the intermediate outer surfaces 24d, the measurement outlet 36 is opened in the width direction X. In these cases, the opening direction of the measurement outlet 36 is different from both the opening direction of the inflow port 33 and the opening direction of the outflow port 34.

As Modification 3, the bypass passage 30 may have the measurement channel 32 but not the flow channel 31. In this case, the measurement inlet 35 is formed on the outer surface of the housing 21 like the measurement outlet 36, and the air flowing through the intake passage 12 flows into the bypass passage 30 from the measurement inlet 35.

As Modification 4, a throttle portion such as the detection throttle portion 37 may be provided in the branch path 32a or the guide path 32b while at least a part of the measurement channel 32 is provided upstream of the sensing portion 22. The detection throttle portion 37 may include a pair of extending surfaces that extend from the inner wall surface of the housing body 24 toward the sensing portion 22 in the width direction X, and a flat surface that extends over the extending surfaces and that extends straight in the depth direction Z. The extending surface may extend straight in the width direction X or extend straight in a direction inclined with respect to the width direction X. Further, the extending surface may be a curved surface curved so as to expand outward or a curved surface curved so as to be recessed inward. The detection throttle portion 37 may have only the upstream extended surface of the pair of extended surfaces. In this configuration, the flat surface extends to the downstream side of the detection path 32c.

As Modification 5, the correction calculator 60a may calculate the correction amount Q in the same unit as the uncorrected output value S1 such as the offset amount, instead of the correction amount Q indicating the correction ratio such as the gain amount. In this case, the pulsation error correcting unit 61 calculates the corrected output value S2 by adding the correction amount Q to the uncorrected output value S1. In the sixth embodiment, the correction calculator 60a may calculate the correction amount Q in the same unit as the uncorrected average air volume Gave1. In this case, the pulsation error correcting unit 61 calculates the corrected average air volume Gave3 by adding the correction amount Q to the uncorrected average air volume Gave1.

As Modification 6, the correction circuit 50 may include at least two of the upper extreme determiner 56 of the first embodiment, the lower extreme determiner 81 of the third embodiment, the increase threshold determiner 82 of the fourth embodiment and the decrease threshold determiner 83 of the fifth embodiment. In this case, the frequency calculator 59 calculates the pulsation frequency for each of at least two determination results of the upper extreme determiner 56, the lower extreme determiner 81, the increase threshold determiner 82, and the decrease threshold determiner 83, and calculates the pulsation frequency F by averaging the pulsation frequencies.

As Modification 7, the average air volume calculator 57 may calculate the average air volume Gave by averaging the pulsation minimum, which is the minimum of the air flow during the measurement period, and the pulsation maximum. Further, the average air volume calculator 57 may calculate the average air volume Gave without using the pulsation minimum whose detection accuracy is lower than the maximum of the air flow. The average air volume calculator 57 may calculate the average air volume Gave without using several air flows near the pulsation minimum and the pulsation minimum.

As Modification 8, the processor 45 may process the output value from the sensing portion 22 with a map, a function, a fast Fourier transform FFT, or the like to calculate the pulsation frequency F.

As Modification 9, the ECU 46 and the processor 45 may be capable of bidirectional communication. For example, the ECU 46 may output external information such as engine parameters to the processor 45. Even in this case, the processor 45 calculates the pulsation state such as the pulsation frequency F using the output value of the sensing portion 22 instead of the external information.

As Modification 10, the functions realized by the processor 45 may be realized by hardware and software, or a combination of the hardware and the software. The processor 45 may communicate with, for example, another control device, such as the ECU 46, and the other control device may perform some or all of the processing. The processor 45, when implemented by an electronic circuit, can be implemented by a digital circuit including a large number of logic circuits, or an analog circuit.

The airflow meter 10 may correspond as an example of the flow rate measuring device. The detection throttle portion 37 may correspond as an example of the throttle unit. The sensor subassembly 40 may correspond as an example of the sensing portion. The molding portion 42 may correspond as an example of the body. The processor 45 may correspond as an example of the measurement control device and the measurement control unit. The ECU 46 may correspond as an example of an external device. The upper extreme determiner 56 may correspond as an example of the pulsation state calculator and the condition determiner. The average air volume calculator 57 may correspond as an example of the pulsation state calculator. The pulsation amplitude calculator 58 may correspond as an example of the pulsation state calculator. The frequency calculator 59 may correspond as an example of the pulsation state calculator. The pulsation error calculator 60 may correspond as an example of the error correcting unit. The pulsation error correcting unit 61 may correspond as an example of the flow rate correcting unit. The lower extreme determiner 81 may correspond as an example of the pulsation state calculator and the condition determiner. The increase threshold determiner 82 may correspond to the pulsation state calculator, the condition determiner, and the increase determiner. The decrease threshold determiner 83 may correspond as an example of the pulsation state calculator, the condition determiner, and the reduction determiner. As an example of the average value, the uncorrected average air volume Gave1 may correspond. As an example of the measurement result and the average value, the corrected average air volume Gave3 may correspond. The corrected output value S2 may correspond as an example of the measurement result.

What is claimed is:

1. A measurement control device configured to measure an air flow rate using an output value of a sensing portion that outputs a signal according to a flow rate of air, to output a measurement result of the air flow rate to a predetermined external device, the measurement control device comprising:
a pulsation state calculator that calculates a pulsation state, which is a state of pulsation generated in the air flow rate, using the output value instead of acquiring an output value from the external device; and
a flow rate correcting unit that corrects the air flow rate using the pulsation state calculated by the pulsation state calculator.

2. A measurement control device configured to measure an air flow rate using an output value of a sensing portion that outputs a signal according to a flow rate of air to be drawn into an internal combustion engine, to output a measurement result of the air flow rate to a predetermined external device, the measurement control device comprising:
a pulsation state calculator that calculates a pulsation state, which is a state of pulsation generated in the air flow rate, using the output value;
a flow rate correcting unit that corrects the air flow rate using the pulsation state calculated by the pulsation state calculator; and
a filter unit that removes a component having a predetermined cutoff frequency from a waveform representing a time change of the output value, wherein
a frequency of a waveform representing a time change of rotation speed of the internal combustion engine is defined as a rotation fluctuation frequency, and
the cutoff frequency is set to a positive real number multiple of the rotation fluctuation frequency.

3. The measurement control device according to claim 2, wherein the cutoff frequency is variably set to a larger value as the rotation speed is higher.

4. The measurement control device according to claim 1, further comprising:
an error calculator that calculates a pulsation error that is an error generated in the air flow rate when the output value includes pulsation; and
a correction calculator that calculates a correction amount using the pulsation error calculated by the error calculator, wherein
the flow rate correcting unit corrects the output value with the correction amount and calculates a corrected output value as the measurement result.

5. The measurement control device according to claim 1, further comprising:
an error calculator that calculates a pulsation error that is an error generated in the air flow rate when the output value includes pulsation; and
a correction calculator that calculates a correction amount using the pulsation error calculated by the error calculator, wherein
the flow rate correcting unit calculates an average value of the output values, and calculates a corrected value of the air flow rate by correcting the average value by the correction amount.

6. The measurement control device according to claim 1, wherein
a pulsation parameter indicating the pulsation state includes a pulsation frequency which is a frequency of pulsation generated in the air flow rate, and
the pulsation state calculator has a frequency calculator that calculates the pulsation frequency using the output value.

7. The measurement control device according to claim 6, wherein
the pulsation state calculator has a condition determiner configured to determine whether or not the output value corresponds to a predetermined specific condition, and
the frequency calculator calculates the pulsation frequency using a time interval between a timing when the output value meets the specific condition and a timing when the output value next meets the specific condition.

8. The measurement control device according to claim 6, wherein
an upper extreme represents the output value when a variation in the output value is changed from increasing to decreasing,
the pulsation state calculator has an upper extreme determiner that determines whether the output value reaches the upper extreme, and
the frequency calculator calculates the pulsation frequency using a time interval between a timing when the output value reaches the upper extreme and a timing when the output value next reaches the upper extreme.

9. The measurement control device according to claim 8, wherein
when the output value does not become lower than or equal to a predetermined lower threshold in a period from a last timing when the upper extreme appears last time to a present timing when the upper extreme appears this time in the waveform representing the time change of the output value, the upper extreme determiner cancels the upper extreme that appears this time by making a negative determination.

10. The measurement control device according to claim 9, wherein the lower threshold is set based on at least one of the average value of the air flow rate and the pulsation frequency.

11. The measurement control device according to claim 6, wherein
a lower extreme represents the output value when a variation in the output value is changed from decreasing to increasing,
the pulsation state calculator has a lower extreme determiner configured to determine whether the output value reaches the lower extreme, and
the frequency calculator calculates the pulsation frequency using the time interval between the timing when the output value reaches the lower extreme and the timing when the output value next reaches the lower extreme.

12. The measurement control device according to claim 11, wherein
when the output value does not become higher than or equal to a predetermined upper threshold in a period from a last timing when the lower extreme appears last time to a present timing when the lower extreme appears this time in the waveform representing the time change of the output value, the lower extreme determiner cancels the lower extreme that appears this time by making a negative determination.

13. The measurement control device according to claim 12, wherein the upper threshold is set based on at least one of an average value of the air flow rate and the pulsation frequency.

14. The measurement control device according to claim 6, wherein
the pulsation state calculator has an increase determiner that determines whether the output value exceeds a predetermined increase threshold while the output value is increasing, and
the frequency calculator calculates the pulsation frequency, while the output value increases, using a time interval between a timing when the output value exceeds the increase threshold and a timing when the output value exceeds the increase threshold next time.

15. The measurement control device according to claim 14, wherein
when the output value does not reach a predetermined upper side threshold while the output value increases in a period from a timing when the output value exceeds the increase threshold last time to a timing when the output value exceeds the increase threshold this time, the increase determiner cancels the timing when the output value exceeds the increase threshold this time by making a negative determination.

16. The measurement control device according to claim 6, wherein
the pulsation state calculator has a decrease determiner that determines whether the output value exceeds a predetermined decrease threshold while the output value is decreasing, and
the frequency calculator calculates the pulsation frequency, while the output value decreases, using a time interval between a timing when the output value exceeds the decrease threshold and a timing when the output value exceeds the decrease threshold next time.

17. The measurement control device according to claim 16, wherein
when the output value does not reach a predetermined lower side threshold while the output value decreases in a period from a timing when the output value exceeds the decrease threshold last time to a timing when the output value exceeds the decrease threshold this time, the decrease determiner cancels the timing when the output value exceeds the decrease threshold this time by making a negative determination.

18. The measurement control device according to claim 6, wherein the flow rate correcting unit is prohibited from correcting when the pulsation frequency calculated by the frequency calculator is higher than a predetermined frequency threshold.

19. The measurement control device according to claim 6, wherein
a pulsation parameter indicating the pulsation state includes a pulsation amplitude that is an amplitude of the pulsation generated in the air flow rate, and
the pulsation state calculator includes a pulsation amplitude calculator that calculates the pulsation amplitude using the output value.

20. The measurement control device according to claim 19, wherein the flow rate correcting unit is prohibited from correcting when the pulsation amplitude calculated by the pulsation amplitude calculator is smaller than a predetermined pulsation amplitude threshold.

21. The measurement control device according to claim 20, wherein the pulsation amplitude threshold is set based on at least one of the average value of the air flow rate and the pulsation frequency.

22. The measurement control device according to claim 6, wherein the frequency calculator calculates the pulsation frequency by excluding frequencies higher than or equal to an upper limit frequency or lower than a lower limit frequency.

23. The measurement control device according to claim 6, wherein the frequency calculator calculates the pulsation frequency by excluding frequencies having a change rate equal to or higher than an upper limit change rate or lower than a lower limit change rate.

24. A flow volume measuring device configured to measure an air flow rate, comprising:
a measurement channel having a measurement inlet through which air flows in and a measurement outlet through which the air flows out;
a sensing portion that outputs a signal according to the flow rate of the air in the measurement channel; and
a measurement control unit that measures the air flow rate using the output value of the sensing portion and outputs the measurement result of the air flow rate to a predetermined external device, wherein
the measurement control unit has
a pulsation state calculator that calculates the pulsation state, which is a state of pulsation generated in the air flow rate, by using the output value instead of acquiring an output value from the external device, and
a flow rate correcting unit that corrects the air flow rate using the pulsation state calculated by the pulsation state calculator.

25. The flow volume measurement device according to claim 24, further comprising:
a flow channel having an inlet through which the air flows in and an outlet through which the air flows out, wherein
the measurement channel is a branch passage branched from the flow channel.

26. The flow volume measuring device according to claim 24, further comprising: a throttle portion that gradually narrows the measurement channel from the measurement inlet toward the sensing portion.

27. The flow volume measuring device according to claim 24, further comprising:
a sensing unit including the sensing portion, the measurement control unit, and a body that protects the sensing portion and the measurement control unit; and
a housing that defines the measurement channel and houses the sensing unit.
